(19) United States
(12) Patent Application Publication
(10) Pub. No.: US 2026/0213507 A1
(43) Pub. Date: Jul. 23, 2026

(54) STRIPPING TOOL, PAIR OF TOOL PARTS FOR A STRIPPING TOOL AND METHOD FOR STRIPPING A CABLE

(71) Applicant: GUSTAV KLAUKE GMBH, Remscheid (DE)

(72) Inventor: Egbert FRENKEN, Heinsberg (DE)

(73) Assignee: GUSTAV KLAUKE GMBH, Remscheid (DE)

(21) Appl. No.: 19/141,219

(22) PCT Filed: Jan. 24, 2024
(86) PCT No.: PCT/EP2024/051600

§ 371 Date: Jun. 19, 2025

(30) Foreign Application Priority Data
Jan. 27, 2023 (DE) 10 2023 102 042.0

(51) Int. Cl. H02G 1/12

(52) U.S. Cl. CPC H02G 1/1224

(57) ABSTRACT

A stripping tool includes tool jaws having first and second tool parts for stripping a cable. Each tool part has a cutting body which includes cutting parts displaceable in an axial direction relative to a tool part base orthogonally to the engagement direction. Guide surfaces of the cutting body and the tool part base are operatively connected and provide for displacement after overcoming a holding force. The guide surfaces extend at a same obtuse angle to the engagement direction. An application of force of the cutting body can be attained solely by a displacement of the tool jaws in the engagement direction, which application of force leads to a displacement of the guide surfaces of the cutting body, and thus of the cutting body, relative to the guide surfaces of the tool part base with a movement component corresponding to the angle in the axial direction.

### FIELD OF TECHNOLOGY

The disclosure relates to a stripping tool comprising a pair of tool jaws, which can be displaced towards one another for a stripping process, having a first tool jaw and a second tool jaw, and comprising a pair of tool parts, having a first tool part and a second tool part, for stripping a cable having a cable core and an insulation sheath, whereby cutting parts are further provided for acting on the cable during a stripping process, whereby each tool part has a cutting body for receiving a partial region of the cable, whereby the cutting body has a cutting parts comprising a cutting tip, whereby the cutting tip limits a free space of the cutting body, in which it is provided to receive the cable core, whereby the tool part has a tool part base, which is received on the tool jaw, whereby the cutting body of the tool part can be displaced in an axial direction relative to the tool part base orthogonally to the engagement direction.

The disclosure furthermore relates to a pair of tool parts for a stripping tool of the above-mentioned type.

A method for stripping a cable having a cable core and an insulation sheath is additionally described, with the method steps:
arranging the cable between two opposite cutting bodies, which each have at least one cutting parts, of a first tool part and of a second tool part;
displacing the first tool part towards the second tool part in an engagement direction;
cutting an axial partial section of the insulation sheath of the cable by using the cutting parts of the first tool part and of the cutting parts of the second tool part.

### PRIOR ART

Stripping tools of the type in question as well as pairs of tool parts for them and methods for stripping a cable are known. By using stripping tools of this type, a stripping of a cable can at least be prepared in that the insulation sheath of the cable is severed over an axial partial section along the longitudinal extension of the cable by means of the cutting parts. After this, the removal of the insulation section, which is separated from the insulation sheath, which remains on the cable side, usually takes place by hand. For example, stripping tools of this type are known from the U.S. Pat. No. 10,554,006 B2, the EP 0 780 943 A1, or the EP 3 718 185 A1 (US 2021/0006049 A1).

The stripping tools for notching the insulation sheath can preferably be hydraulically and/or electrically operated devices comprising tool jaws, which can be moved towards one another. The tool parts, which have the cutting parts, can be formed integrally with the tool jaws, but, as usual and generally preferred, can also be exchangeably received on the tool jaws. Stripping tools are furthermore known, in the case of which either both tool jaws are formed so as to be actively displaceable onto the respective opposite tool jaw or at least one of the tool jaws is displaceable, while the opposite tool jaw is formed in a stationary manner on the stripping tool.

### SUMMARY OF THE DESCRIPTION

Based on the above-described prior art, the object is to specify a stripping tool of the type in question as well as a pair of tool parts for a stripping tool and a method for stripping a cable, by means of which an advantageous cutting result and an advantageous stripping of a cable section can be attained.

A possible solution of the object is at hand in the case of a stripping tool, which focusses on that the tool part base and the cutting body have guide surfaces, which are operatively connected to one another and which provide for the displacement after overcoming a holding force, whereby the guide surfaces extend at a same obtuse angle to the engagement direction, whereby an application of force of the cutting body can be attained solely by means of a displacement of the tool jaws in the engagement direction, which application of force leads to a displacement of the guide surfaces of the cutting body, and thus of the cutting body, relative to the guide surfaces of the tool part base with a movement component corresponding to the angle in the axial direction.

The holding force can be given in various ways, as will be described below. It can be attained by means of a corresponding setting of a frictional force, but it can also be attained by means of a positive connection.

According to the proposed formation of the stripping tool, an advantageous cutting result and a stripping result results on the cable. The stripping tool does not only provide for a notching of the insulation sheath of the cable, which can be handled easily, but, in fact, also a shifting or removing, respectively, of the insulation section from the cable core. For this purpose, the tool part has a tool part base, which is mounted, in particular in a stationary manner, relative to the tool jaw or which is formed integrally with the tool jaw, and a cutting body, which can be displaced relative to the tool part base. The cutting body can be displaced in the axial direction of the tool part along the oblique guide surface, in the direction of the longitudinal extension of a cable arranged between the opposite tool parts.

In addition to the axial displaceability of the cutting body, the tool part itself and/or the cutting body can preferably be pivoted about a longitudinal axis corresponding to the axial direction relative to the tool jaw or to the tool part base, respectively. The pivotability can be given about a comparatively small pivot angle, preferably approximately between 1 degree and 5 degrees. Independently thereof or in addition, the tool part base can in particular have a play to the tool jaw in order to be able to dissipate an acting force, which is introduced into the cable to cut via the tool jaw, during the cutting process, namely so that the cutting parts of the opposite tool parts do not cant or block one another, respectively.

The stripping tool can carry out a cutting of the insulation sheath and shifting of the insulation sheath relative to the cable core in two consecutive steps by means of the tool parts formed in this way. The shifting of the insulation sheath can preferably occur only after overcoming the holding force. The holding force does not yet allow for a movement between the guide surfaces, which are operatively connected. The holding force can be attained by setting the frictional force between the cutting body and the insulation sheath. As will be described in more detail below, said holding force can also be attained by means of a positive connection. As long as the cutting parts is only in contact with the insulation sheath of the cable but is not yet in contact with the cutting parts of the opposite tool part, only the frictional force between the cutting parts and the insulation sheath act on the cutting parts. A self-locking interlocking of the cutting parts preferably results therefrom, in the case of which a displacement of the cutting body relative to the tool part base in the axial direction does not yet take place. A force acting in the axial direction, which displaces the cutting body along the guide surface relative to the tool part base, is created only when the opposite cutting parts of the stripping tool come into contact with one another or virtually into contact in a second step.

This leads to a shifting of the notched end section of the insulation sheath relative to the cable core, whereby the end section can be removed from the cable core in terms of handling. Bringing the tool jaws together effects the notching of the insulation sheath as well as the shifting of the insulation sheath relative to the cable core.

When the opposite cutting parts contact one another or contact one another except for one or a few millimeters (or fractions thereof), namely when the insulation sheath is completely or almost severed, the system of the opposite cutting parts can be considered to be a single body, on which two forces, which oppose one another, act. An axial force results from the opposing forces, which act essentially transversely to the longitudinal extension of the cable.

The situation of the cutting parts, which stabilizes itself beforehand, is eliminated and the cutting body is shifted relative to the tool part base of the tool part. The resulting axial force is, for example, in the magnitude between 10 percent and 20 percent of the applied force of the stripping tool. This is sufficient in order to shift the insulation sheath relative to the cable core even in the case of comparatively large cable cross sections, optionally also with a comparatively hard material of the insulation sheath.

Due to the axial shifting, the end-side, notched end section of the insulation sheath can be separated from the remaining insulation sheath, even if the end section has not been completely cut through yet. The force generated in the axial direction can optionally also produce a tear-off, which is still required.

Due to the fact that the insulation sheath does not have to be cut through completely prior to the displacement of the cutting body relative to the tool part base, a certain distance between the cutting parts and the cable core can be maintained, which prevents a notching of the strands of the cable core.

The above-mentioned principle of the stripping tool can be applied to cables with different outer diameters. The stripping tool is furthermore also suitable for cables, which have several insulation sheaths. The insulation material itself can be softer or harder, for example made of rubber, PVC, PE, or others. The cable core of the cable can be massive or can consist of several strands. The shape of the cutting parts can additionally also be adapted to different cross sectional shapes of the cable, for example to flat cables, sectioned cables, or cables comprising a plurality of separately insulated lines.

The tool parts are preferably designed to cut cross sections between in particular 25 mm² and 300 mm². In practice, the proposed stripping tool has proven itself, for example, for cables, the cable core of which approximately has a diameter of 9 mm to 11 mm, and the insulation sheath of which has an outer diameter of approximately 13 mm to 19 mm. The cutting tip of the cutting parts, which is preferably formed to be semicircular, can limit, for example, a free space, which has a diameter of 12 mm. In particular an angle between approx. 5 degrees and 20 degrees has turned out to be favorable as cutting angle of the cutting parts.

The above-mentioned information, however, is to only be understood in an exemplary manner in order to describe the approximately magnitude of the stripping tool or the components thereof, respectively, and are not to be understood to be limiting in any way.

The tool part base advantageously has a wedge structure comprising at least one guide surface or at least two guide surfaces, which taper towards a common wedge peak in opposing axial directions. A wedge angle of the wedge structure thereby specifies the angle of the guide surfaces to the axial direction of the tool part. The wedge angle, i.e. the slope of the guide surfaces is preferably between 5 degrees and 15 degrees, preferably approx. 9 degrees. Based on the axial direction of the tool part base, the wedge peak of the wedge structure is arranged in an axial position, which, in the initial position, is assigned to the axial position of the cutting tip, preferably corresponds approximately to the axial position of the cutting tip of the cutting parts. This is then preferably simultaneously also that axial position, in which the cutting of the insulation sheath of the cable takes place in the initial position of the stripping tool. As soon as the insulation sheath is cut through completely or almost completely and the cutting tips of the opposite tool parts thus meet one another or at least further approach one another, the system of the two opposite cutting parts can be considered to be a body, on which forces act, which oppose one another based on the radial direction and which then result in a total force in the axial direction and displace the cutting body including the cutting parts thereof in the axial direction, whereby the cutting body is shifted on the guide surface of the wedge structure assigned to it. This then lastly effects the stripping of the cable. According to one embodiment, the entire surface of the wedge structure can serve as guide surface. It is preferred, however, that only individual, in particular strip-shaped partial regions form the guide surface.

The cutting body is preferably formed in two pieces, comprising two partial cutting bodies, which can be displaced in opposing axial directions when—as described above—the opposite cutting parts of the stripping tool come into contact with one another or when the opposite forces acting on the oblique surfaces of the cutting parts, respectively, result in an axial force. One of the partial cutting bodies can also be formed to only hold or clamp the cable, respectively. Due to the shape of the cutting parts, the axial force acting on the partial cutting body acts in that axial direction, which faces away from the respective other partial cutting body.

A first partial cutting body of the cutting body of a tool part can have, for example, a holding element, which fixes the cable, which is to be stripped. In contrast, a second partial cutting body of the same cutting body or tool part, respectively, has a cutting parts, which distances itself from the holding element due to the opposing axial displacements of the two partial cutting bodies. A shifting of the insulation sheath over a partial section of the length of the cable is attained thereby. The displacement of the guide surfaces to one another as part of a stripping process can also have the result, for example, that the tool jaw or the stripping tool as a whole, respectively, is additionally also displaced relative to the cable or the surrounding area thereof, respectively, in particular in the case of cables, the long end of which, which faces the free end region, is immovably secured in a surrounding area, which can be the case, for example, in the case of underground cables.

Alternatively, both partial cutting bodies of the same tool part can each have a cutting parts, which can be displaced in opposing axial directions. In combination with the above-described wedge structure of the tool part base, it can be attained that each partial cutting body and thus also each cutting parts is moved along a guide surface of the wedge structure, namely in particular in the direction of a sloping ramp of the wedge structure. This also results in the described stripping of the cable.

It is furthermore also possible that opposite tool parts each have a first partial cutting body comprising a cutting parts and a second partial cutting body comprising a holding element. The cutting parts of the first and of the second partial cutting body can thereby be positioned so as to be diagonally offset to one another. This means that a cutting parts of a first tool part is located opposite a holding element of the second tool part and that a holding element of the first tool part is located opposite a cutting parts of the second tool part. A cutting parts of a first tool part thus does not cut against an opposite cutting parts, but, in fact, against a holding element. As soon as a cutting parts of the first tool part and a holding element of the second tool part thus contact one another or almost contact one another when the opposite tool parts move together, the described axial displacement of the cooperating partial cutting bodies of first and second tool part takes place. A holding element could also be formed by a cutting parts, which is formed to be blunt or round or which has a sawtooth profile.

In one embodiment, it is provided that the first partial cutting body has a first cutting parts on a front region facing the second partial cutting body and that the second partial cutting body has a second cutting parts on a front region facing the first partial cutting body. Due to this design, the forces acting on the cutting body can be distributed symmetrically to the two partial cutting bodies. This can advantageously result in a force, which is equally sized in opposing axial directions, so that the partial regions of the insulation sheath of the cable on the left and on the right of the notching point are shifted in opposing directions relative to the cable core.

In the case of the axial displacement of the partial cutting bodies away from one another, not only the cutting body is additionally separated, but, in fact, also the two cutting parts, whereby each cutting parts closes the front side of the respective partial cutting body. At least one of the cutting parts pushes the insulation sheath in front of it during the axial displacement.

The two partial cutting bodies can furthermore be connected by means of at least one resetting element, whereby a resetting force of the resetting element seeks to move the two partial cutting bodies towards one another. The resetting element can in particular be a spring element, for example a helical spring or a leaf spring, the resetting force of which acts in a direction, which moves the two partial cutting bodies towards one another.

The resetting element can end, for example, on a front side of the respective partial cutting body, which faces away from the other partial cutting body. The force thus acts on the outer sides of the cutting body and connects the partial cutting bodies over the entire axial longitudinal extension thereof. Alternatively, it is also possible that the resetting element is arranged on the tool part base or the tool jaw of the stripping tool. A pressure spring, which acts on the cutting body from the outside, namely on a front side, which faces away from the cutting parts of the cutting body, is recommended in this case. The resetting element can also be formed as spring element in this case. In particular a leaf spring is advantageous thereby.

The resetting element ensures that the partial cutting bodies are displaced into an initial position, in which, for example, the cutting parts or a cutting parts and a holding element bear against one another. A displacement opposing the resetting force of the resetting element results only during the axial displacement of the two partial cutting bodies relative to one another, which follows the notching.

The cutting body or partial cutting body, respectively, of the respective tool part can preferably be pivoted about an axial longitudinal extension of the tool jaw relative to the tool jaw. The pivotable arrangement of the cutting body or partial cutting body, respectively, on the tool jaw can advantageously be used to attain a pivoting of a cutting parts around the insulation sheath of the cable. This improves or supports the cutting result because not only a cutting movement in the radial direction, but also in a circumferential direction of the insulation sheath takes place at least at the beginning of a cutting process. The pivotability of the cutting body or partial cutting body, respectively, can furthermore also be used to optionally displace cutting bodies or partial cutting bodies, which are not optimally located in a desired receiving position of the tool jaw, preferably as part of a process of bringing together the tool jaws, during which the opposite tool parts are moved towards one another, and one or two opposite pivotable cutting bodies or partial cutting bodies, respectively, are thus also pivoted into a desired position.

It can furthermore be provided that the cutting body and the partial cutting body are formed conically. A first partial cutting body can in particular taper in the axial direction towards an adjacent second partial cutting body of the same tool part, and a second partial cutting body can taper in the opposing axial direction. According to this design, the partial cutting bodies are, for example, not formed as half cylinders, but, in fact, conically, whereby the diameter thereof tapers. This conical design provides for the pivoting of the partial cutting body about a longitudinal axis of the tool part. The cutting body or partial cutting body, respectively, can pivot in particular by 1 degree to 5 degrees, in particular approximately 2.5 degrees. Corresponding to the conical formation of the cutting body or partial cutting body, respectively, the tool part base is preferably also formed conically on the side facing radially inwards. The conical shapes and sizes of the tool part base and of the cutting body correspond to one another in particular in such a way that, in the initial position, they preferably bear fully against one another. As soon as an axial displacement of the cutting body or partial cutting body, respectively, relative to the tool part base takes place, however, the diameters of tool part base and cutting body or partial cutting body, respectively, no longer match based on the same cross sectional plane, so that the tool part base and the cutting body or partial cutting body, respectively, only still contact one another linearly on their surfaces facing one another. The cutting body or the partial cutting bodies, respectively, is or are thus particularly preferably aligned relative to the tool part base in the axial direction. The longitudinal axes of two partial cutting bodies within the tool part base also remain parallel to one another.

In the case of the formation of the cutting body with two partial cutting bodies, it can in particular be provided that each partial cutting body can be pivoted by approximately 2.5 degrees. A corresponding movement of the partial cutting bodies and thus also of the assigned cutting parts and/or holding elements is attained thereby while moving together the tool parts, while the one cutting parts or the cutting parts, respectively, notch the insulation sheath of the cable. An axial displacement of the cutting body or of the partial cutting bodies in the axial direction, respectively, preferably does not yet take place in this section of the cutting process.

It can in particular be provided that the cutting body or the partial cutting bodies, respectively, have a pretensioning into a pivoted-forward position. This can lead to the already mentioned more favorable cutting behavior of the one or of the cutting parts, respectively. The tapering formation of the conical partial cutting body or cutting body, respectively, additionally ensures that the axes of the partial cutting bodies remain parallel to one another, if possible.

The cutting body of the tool part can furthermore have an end stop for the cable received therein. The axial end stop of the cutting body limits the length of the cable inserted between the tool jaws of the stripping tool. A length of the core of the cable exposed by the stripping can be simultaneously determined therewith.

The axial end stop can particularly preferably be manually displaced relative to the tool jaws by a user of the stripping tool. The end stop can be displaced outwards, for example along a guide rail of the cutting body of the tool part base or of the tool jaw. The end stop is thus mounted on the cutting body, the tool part base, or the tool jaw. It can in particular be provided that, for example, the cutting body has a guide rail, which passes through a partial region of the end stop, and the end stop can thus be displaced towards the tool jaw or can be displaced away from it, respectively.

A lock, which can fix the end stop in a desired position, is thereby preferably assigned to the end stop. According to one embodiment, a latching means or a screw can be provided in this respect, which applies a holding force to the partial region of the cutting body, for example the guide rail.

Based on the stripping tool, it can lastly also be provided that at least the first tool jaw can be displaced linearly or can be pivoted about a pivot axis relative to the second tool jaw. The tool jaws can thus generally be moved together in different ways. The stripping tools comprising tool jaws, which can be shifted linearly to one another, thereby form one group of stripping tools. In this case, the stripping tool is formed, for example, so that it has a tool jaw, which is stationary relative to a handle part of the tool body and a tool jaw, which can be shifted linearly, in contrast, whereby the shiftable tool jaw is displaced towards the stationary tool jaw for the stripping process. The second group of stripping tools includes tools, in the case of which at least one tool jaw, but preferably both tool jaws, is pivotable about a pivot axis. In the case of two tool jaws, which can be displaced towards one another, the tool jaws can be pivotable about a common pivot axis or also about a respective separate pivot axis.

In addition to the stripping tool, a pair of tool parts for a stripping tool is proposed, whereby the stripping tool is formed according to the above-described type. The stripping tool thus has a pair of tool parts comprising a first tool part and a second tool part, for stripping a cable having a cable core and an insulation sheath, whereby cutting parts are further provided for acting on the cable during the stripping process, whereby each tool part has a cutting body for receiving a partial region of the cable, whereby the cutting body has a cutting parts comprising a cutting tip, whereby the cutting tip limits a free space of the cutting body, in which it is provided to receive the cable core, whereby the tool part has a tool part base, which is received on the tool jaw, whereby the cutting body of the tool part can be displaced in an axial direction relative to the tool part base orthogonally to the engagement direction, whereby the tool part base and the cutting body, have guide surfaces, which are operatively connected to one another and which provide for the displacement after overcoming a holding force, whereby the guide surfaces extend at a same obtuse angle to the engagement direction, whereby an application of force of the cutting body can be attained solely by means of a displacement of the tool jaws in the engagement direction, which application of force leads to a displacement of the guide surfaces of the cutting body, and thus of the cutting body, relative to the guide surfaces of the tool part base with a movement component in the axial direction corresponding to the angle.

The pair of tool parts is thus designed in such a way that it can fulfill the function in the illustrated manner when being received in a corresponding stripping tool. This design results in the advantages and features, which have been described above with regard to the stripping tool. The features of the stripping tool, which relate to the formation of the tool parts, also apply accordingly for the proposed pair of tool parts for a stripping tool.

Finally, a method for stripping a cable having a cable core and an insulation sheath is proposed, whereby the method includes the following method steps:
arranging the cable between two opposite cutting bodies, which each have at least one cutting parts, of a first tool part and of a second tool part;
displacing the first tool part towards the second tool part in an engagement direction;
cutting an axial partial section of the insulation sheath of the cable by using the cutting parts of the first tool part and of the cutting parts of the second tool part; displacing the cutting body of the tool part relative to a tool part base of the tool part in an axial direction, which is oriented orthogonally to the engagement direction, whereby guide surfaces, which are operatively connected to one another and which extend at a same obtuse angle to the engagement direction, of the tool part base and of the cutting body provide for the displacement of the cutting body after overcoming a holding force, whereby an application of force of the cutting body takes place solely by a displacement of the tool jaws in the engagement direction, which application of force leads to a displacement of the guide surfaces of the cutting body, and thus of the cutting body, relative to the guide surfaces of the tool part base with a movement component in the axial direction corresponding to the angle;
separating the axial partial sections of the insulation sheath of the cable by displacement of the cutting body relative to the tool part base.

The proposed method provides for a procedure in at least two steps. The first step includes the displacement of the opposite tool parts towards one another for cutting the insulation sheath of the cable. The tool parts are thereby moved towards one another until the cutting tips of the opposite cutting parts or at least partial regions of the opposite cutting parts come into contact with one another or at least approximately come into contact with one another. During the first method step, a self-locking of the cutting parts preferably takes place, whereby only the cutting of the insulation sheath takes place, but not yet a relevant axial shifting of the cutting parts and thus of the insulation sheath relative to the cable core. The second step of the procedure is triggered in that the user displaces the tool jaws and thus also the tool parts of the stripping tool further towards one another, which results in an elimination of the movement inhibition, in particular optionally of the self-locking effect of the cutting parts, preferably due to the totality of forces, which act on the tool parts, and the forces having an opposing effect on the cutting parts add up to a resulting total force in the axial direction, which then lastly effects the axial displacement of the cutting body or of the partial cutting body thereof, respectively. In particular two partial cutting bodies are thus moved away from one another, namely in opposing axial directions, so that the cut end section of the insulation sheath is shifted relative to the cable core of the cable.

The displacement of the cutting body relative to the tool part base takes place by means of an application of force by the displacement of the first tool part towards the second tool part and has the effect that at least a partial region of the cutting body of the respective tool part is pressed onto at least one guide surface of a wedge structure, which slopes in the axial direction. In response to continued application of force, the cutting body or the partial region of the cutting body is guided downwards along the sloping guide surface, starting at a wedge peak of the wedge structure, and is thus simultaneously displaced in the axial direction, until an end position is reached. The same results in the case of an adapted conical formation of the cooperating guide surfaces. The end position is specified by the tool jaws, which are moved together or optionally by a resetting element, respectively, the resetting force of which wants to displace the cutting body or the partial region of the cutting body back into the initial position, or a resetting element, respectively, which connects two partial cutting bodies of the cutting body to one another and seeks to displace them one on top of the other. The end position is further specified at least by a meeting of the tool parts, in which the cutting means are arranged. The end position is further specified at least by a meeting of the tool part base of the first tool part and the tool part base of the second tool part.

The displacement of the cutting body in the axial direction preferably includes that a first partial cutting body and a second partial cutting body of the cutting body are displaced relative to one another in the opposing axial directions. In particular a symmetry of the displacement movements of the partial cutting bodies relative to the tool part tool part base of the respective tool part can be attained thereby. Starting at the cutting point, a force is thus exerted on the insulation sheath in two opposing directions, which simplifies the stripping of the cable. The displacement of the two partial cutting bodies relative to one another can include, on the one hand, that two cutting parts are displaced relative to one another. Alternatively, the displacement of the two partial cutting bodies can include that a first partial cutting body comprising a cutting parts is removed from a second partial cutting body comprising a holding element.

With regard to the two partial cutting bodies of the cutting body, it can in particular be provided that each partial cutting body supports a cutting parts, whereby a first cutting parts arranged on a front region of the first partial cutting body facing the second partial cutting body is separated from a second cutting parts arranged on a front region of the second partial cutting body facing the first partial cutting body. An in particular central and symmetrical separation of the two cutting parts of the one cutting parts thus simultaneously also takes place when displacing the two adjacent partial cutting bodies away from one another.

### BRIEF DESCRIPTION OF THE DRAWINGS

The below description is on the basis of the enclosed drawings, which only represent exemplary embodiments. A component part, which is only described based on one of the exemplary embodiments and which is not replaced with another component part in the case of a further exemplary embodiment due to the special feature emphasized there, is thus also described as at least possibly available component part for the further exemplary embodiment. In the drawings:

FIG. 1 shows a stripping tool in perspective illustration including a pair of tool parts arranged in tool jaws, relating to a first embodiment;

FIG. 2 shows a working head of the stripping tool with an exploded perspective illustration of the pair of tool parts according to FIG. 1, and a cable shown in perspective which is to be cut by the stripping tool;

FIG. 2a shows a perspective illustration of the tool jaws;

FIG. 2b shows a cross-section view of the tool parts according to the line IIb in FIG. 2a;

FIG. 2c shows a cross-section view according to the line 11c in FIG. 2;

FIG. 3 shows a perspective illustration of the pair of tool parts in a partially moved-together initial position;

FIG. 4 shows a perspective illustration of into one of the tool parts according to FIG. 3;

FIG. 5 shows a perspective illustration of the pair of tool parts according to FIG. 3 in a completely moved-together end position;

FIG. 6 shows a perspective illustration of into one of the tool parts according to FIG. 5;

FIG. 7 shows a cross-section through the pair of tool parts according to the line VII in FIG. 3;

FIG. 8 shows a cross-section view through the pair of tool parts according to the line VIII in FIG. 5;

FIG. 9 shows a stripping tool in perspective illustration comprising a pair of tool parts arranged in tool jaws, relating to a further embodiment;

FIG. 10 shows a perspective illustration of one of the tool parts comprising a tool part base and a cutting body for a cable;

FIG. 11 shows a a perspective illustration of the pair of tool parts according to FIG. 9;

FIG. 12 shows a perspective illustration of the pair of tool parts according to FIG. 11 in a partially moved-together initial position;

FIG. 13 shows a perspective illustration of into one of the tool parts according to the initial position illustrated in FIG. 12, and with a cable laid therein;

FIG. 14 shows a perspective illustration of the pair of tool parts according to FIG. 11 in a completely moved-together end position;

FIG. 14a shows a cross-section view according to the line XIVa in FIG. 14;

FIG. 15 shows a cross-section view according to the line XV in FIG. 14, and an enlargement of a portion shown in the circle therein;

FIG. 16 shows a cross-section view a pair of tool parts according to a further embodiment, relating to a moved-together end position, and an enlargement of a portion shown in the circle therein;

FIG. 17 shows a perspective illustration of a tool part according to a further possible embodiment;

FIG. 18 shows a perspective illustration of a journal for the tool part illustrated in FIG. 17;

FIG. 19 shows an enlarged perspective view of the region XIX in FIG. 17;

FIG. 20 shows a cross-section view, shown in perspective, according to the line XX in FIG. 17.

### DESCRIPTION OF THE EMBODIMENTS

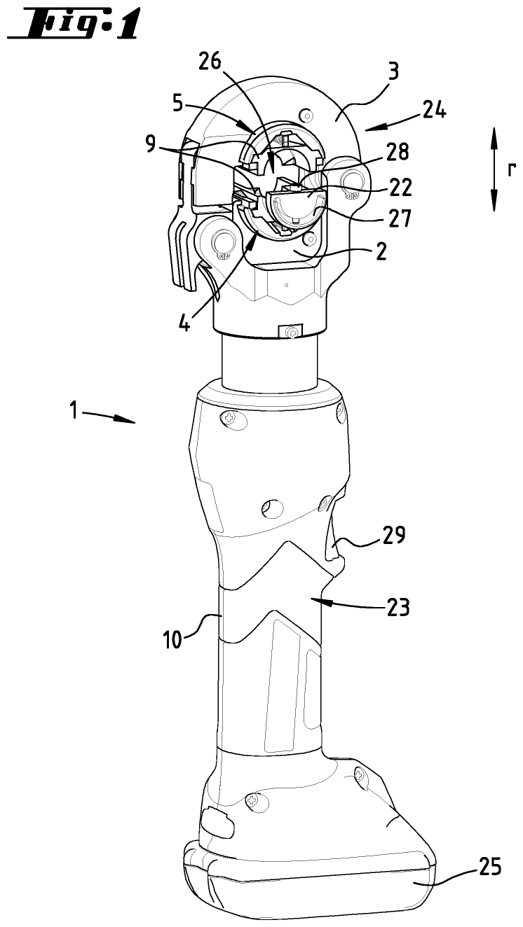

What is illustrated and described, initially with reference to FIG. 1, is a stripping tool 1, which is formed here in the shape of a rod-like drive device part 10 comprising a handle region 23 and a working head 24. Alternatively, the stripping tool 1 can, for example, also be formed as an essentially gun-like drive device part.

Drive device parts of this type or stripping tools, respectively, are known, for example, from the WO 2008/138987 A2 (U.S. Pat. No. 8,056,473 B2) or also from the WO 2003/084719 A2 (U.S. Pat. No. 7,254,982 B2). The stripping tool 1 can alternatively have an electromotive spindle drive. Such a hand tool is known, for example, from the WO 2014/009363 A1 (U.S. Pat. No. 10,468,847 B2). The content of these WO publications or US publications, respectively, is hereby included in its entirety into the disclosure of solutions described herein, also for the purpose of including features of these WO publications or US publications, respectively, in claims of the present documents.

Two tool jaws 2, 3, which can be moved linearly towards one another, are arranged in the working head 24, whereby a movable first tool jaw 2 can preferably be linearly displaced onto a preferably stationary second tool jaw 3 during the operation of the stripping tool 1. The drive preferably takes place electro hydraulically, for the purpose of which an accumulator 25 can further for example be provided on the end side of the handle region 23, which accumulator 25 can further also serve the purpose of electrically supplying, for example, a hydraulic medium pump (not shown) and a control unit (not shown).

The tool jaws 2, 3 are carriers of a pair of tool parts 4, 5, which are preferably held in an exchangeable manner in the tool jaws 2, 3, having a first tool part 4 and a second tool part 5. A screwing or latching fixation of the tool parts 4, 5 can in particular be provided in the respective tool jaw 2, 3, in particular for the simplified removal of the tool parts 4, 5 from the tool jaws 2, 3 or for changing the tool parts 4, 5.

The tool parts 4, 5 can, and as also preferred, be identically formed, so that either tool part 4, 5 can be provided on either tool jaw 2, 3.

The tool parts 4, 5 of the embodiments illustrated in the following figures are formed for stripping a cable 8. In the usual way, such a cable 8 has a cable core 6 preferably comprising a plurality of strands and an insulation sheath 7 surrounding the cable core 6. In order to be able to establish an electrically conductive connection of the cable 8, the cable core 6 needs to initially be exposed in the corresponding section of the cable 8 by removing an axial section of the insulation sheath 7.

In use, according to a preferred embodiment, the tool parts 4, 5 completely remove an end-side insulation section of the insulation sheath 7 by notching and/or cutting through the insulation sheath 7 at a specified position of the cable 8, which is enclosed by the tool parts 4, 5.

Each tool part 4, 5 includes a cutting body 9 and a tool part base 12 in which the cutting body 9 is held. The tool part base 12 and the cutting bodies 9 are operatively connected to each other. Each cutting body 9 is formed of a pair of semi-cylindrical partial cutting bodies 13, 14 held in the tool part base 12. The two partial cutting bodies 13, 14 are together referred to as the cutting body 9. Each tool part base is mounted, in particular in a stationary manner, relative to the tool jaw or formed integrally with the tool jaw. The two partial cutting bodies 13, 14 can be displaced relative thereto in an axial direction a. The cutting bodies 9 define a receiving region, formed when viewed in cross-section transversely to a longitudinal extension of the cable 8 guided between the tool parts 4, 5. Each cutting body 9 is coupled to one of the tool parts 4, 5 and partially surrounds the inserted cable 8, for example essentially semi-circularly. The two cutting bodies 9 accordingly preferably supplement one another to form a receptacle, which is generally cylindrical as a whole, comprising a free space 26 for receipt of the cable 8 therein, in the moved-together state of the tool parts 4, 5. The receipt means that very usually, of course depending on a diameter of the cable, a partial cutting of the cable is given once the cable is received in the free space.

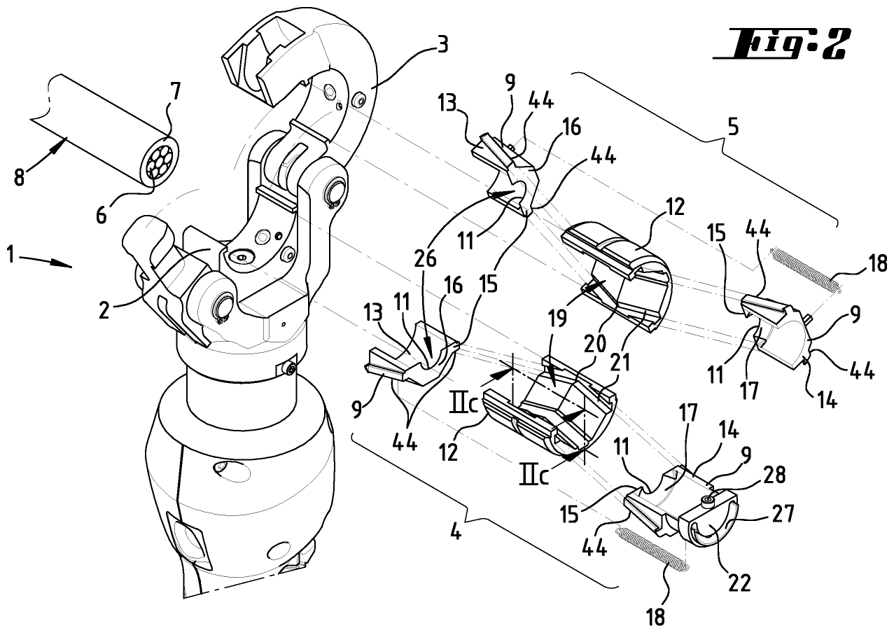

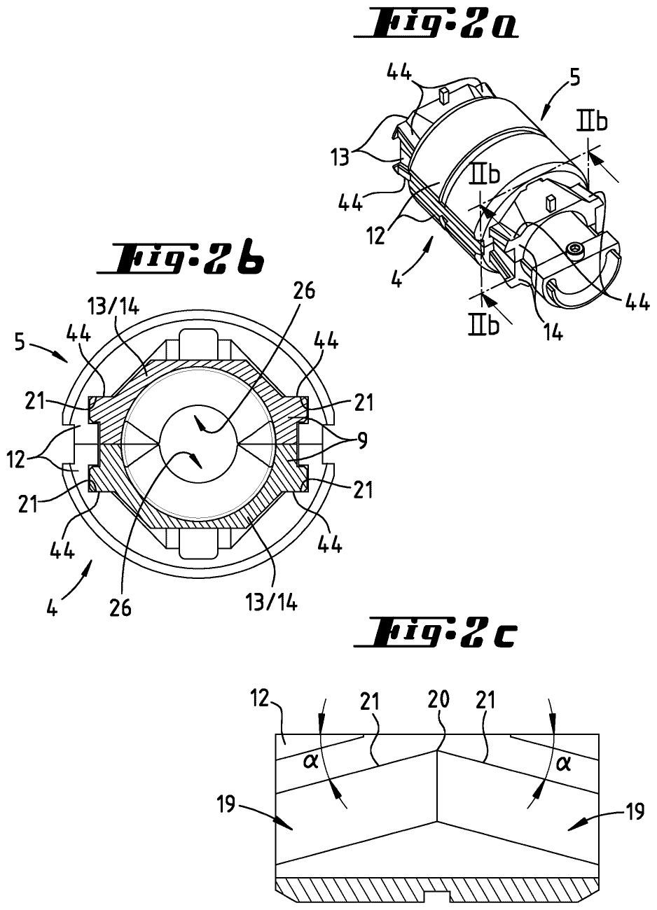

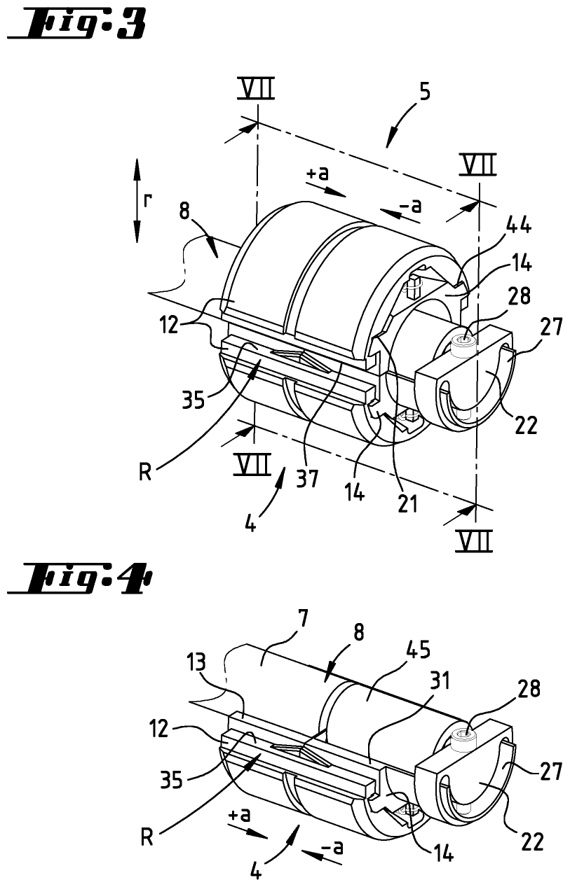

As can further be seen starting at FIG. 2, each semi-cylindrical partial cutting body 13, 14 in the case of this exemplary embodiment has a cutting part 16, 17 comprising a cutting tip 11. Based on the cross-section, the cutting tip 11 is likewise formed semi-circularly and limits the free space 26, in which free space 26 it is provided to receive the cable core 6 of the cable 8. The free space 26 thus essentially has a diameter, which corresponds to the diameter of the cable core 6 and which is slightly larger, for example larger by 1 mm or 2 mm, or fractions thereof. The cutting parts 16, 17 are preferably formed integrally on the respective partial cutting body 13, 14 and also preferably of the same material with the cutting body 13, 14. Based on the longitudinal extension of the cutting body 9, in one partial cutting body 13, 14 several cutting parts 16, 17 can be provided one behind the other. The illustration is to not be understood to be limiting here in this respect. With respect to the partially moved-together initial position of the tool parts 4, 5, which is illustrated in FIGS. 3 and 4, radially inwards pointing and one another accordingly facing cutting tips 11 of the opposite cutting parts 16, 17, leave the radially inner free space 26, the diameter of which is adapted to the diameter of the cable core 6 of the cable 8, which is to be stripped. In the later completely moved-together state of the tool parts 4, 5, the cutting parts 16, 17 can thus notch or completely sever the insulation sheath 7 accordingly, all the way into a depth, in which the cutting tips 11 move against the circumference of the cable core 6, preferably without damaging the cable core 6 or individual strands running therein, respectively.

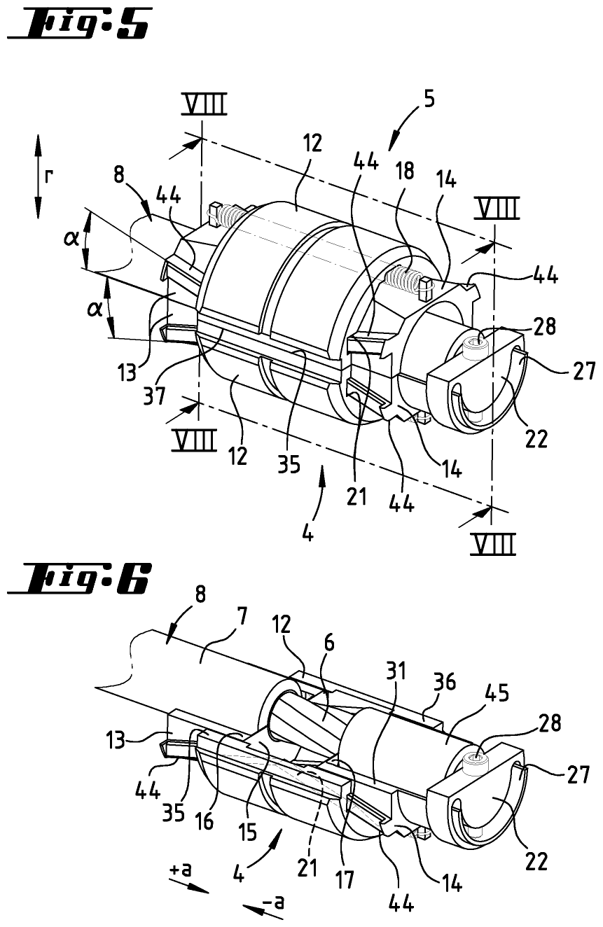

As can in particular be seen from a comparison of FIGS. 3 and 4, which illustrate the initial position of the tool parts 4, 5 after being moved together, which is effected all the way to a contacting, in the case of which the notching into the insulation sheath 7 is effected, to FIGS. 5 and 6, which illustrate the moved-together end position of the tool parts 4, 5, an end region R of the respective partial cutting body 13, 14, based on the circumferential direction, protrudes beyond the tool part base 12. When moving together the tool parts 4, 5, these end regions R of the respective tool part base 12 of the tool parts 4, 5, which protrude in the direction of the respective opposite tool part 4, 5, bear against one another and are displaced by the actuating force applied from the outside—as can be seen, for example, when comparing FIGS. 4 and 6—in the axial direction a on the one hand and in the circumferential direction on the other hand, insofar as a pivotability is provided, and the displacement of the stripped partial section of the insulation sheath 7 in the axial direction a is thus also effected.

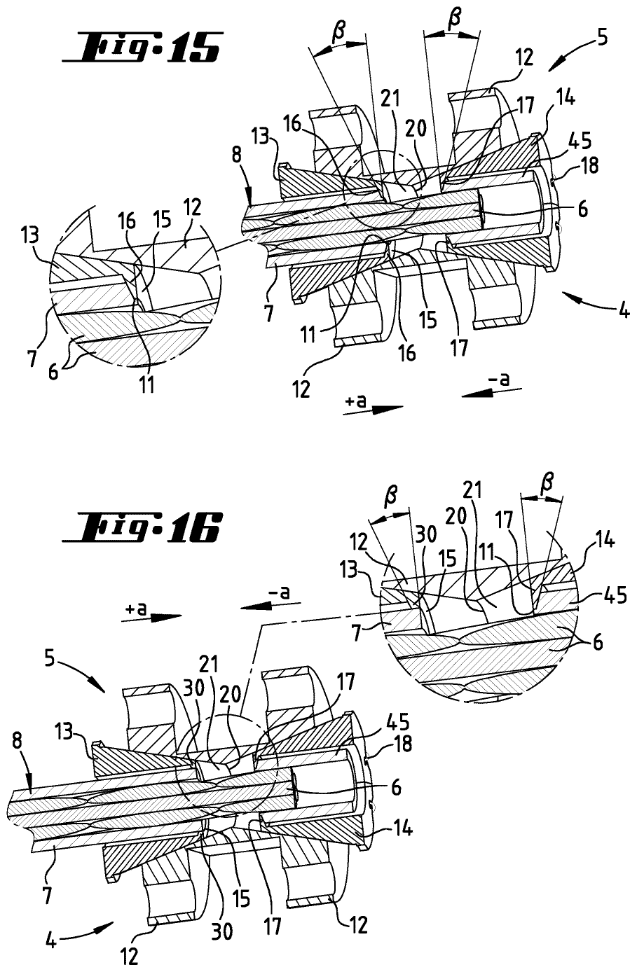

In detail, and thus also with reference to FIG. 11, the partial cutting bodies 13, 14 have contact surfaces 31, 32, 33, and 34. In the case of the partial cutting bodies 13, 14, which are preferably formed in a spherical cap-like manner as a whole, the contact surfaces 31, 32, 33, and 34 are formed on the surfaces, which in each case face the opposite partial cutting bodies 13, 14 in the moved-together position and which extend in the axial direction. These contact surfaces 31, 32, 33, 34 come to bear against one another after the completion of the notching into the insulation sheath 7, for instance in the situation of FIG. 3, and are then displaced jointly in the axial direction a into the position according to FIG. 5 or FIG. 6, respectively, or also FIG. 15 as a result of operatively connected guide surfaces 21, 44 formed on the tool part base 12 and on the partial cutting bodies 13, 14, without a relative shift resulting between the contact surfaces 31, 32, 33, 34, thus with the two opposite partial cutting bodies 13, 14 jointly. The guide surfaces 44 are on the cutting bodies 9, and are the corresponding surfaces to the guide surfaces 21 on the tool base part 12, see e.g. FIG. 2. The guide surfaces 21 and the guide surfaces 44 extend at a same obtuse angle to the engagement direction. The guide surfaces 21, 24 are also addressed as oblique surfaces.

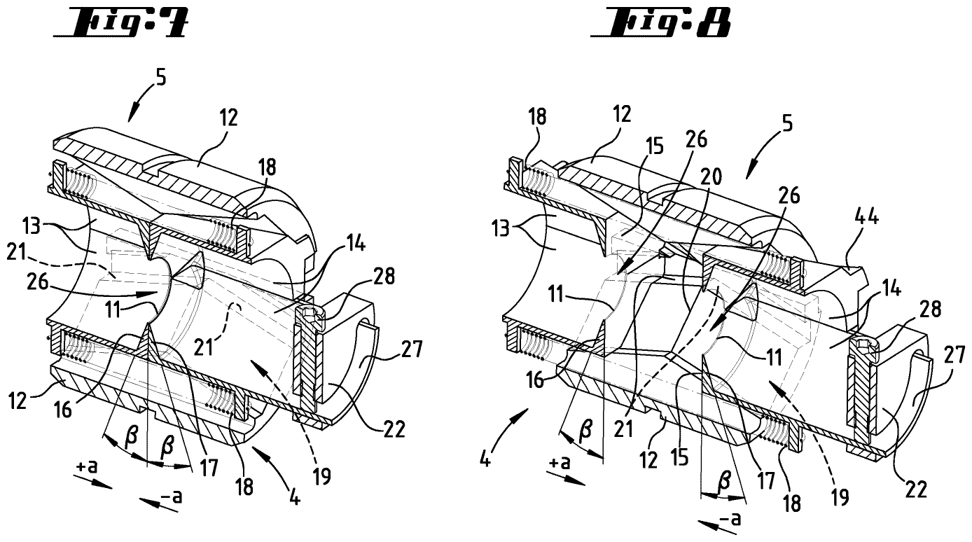

Each cutting body 9 of the opposite tool parts 4, 5 has two partial cutting bodies 13, 14 here in an exemplary manner, each comprising a cutting parts 16, 17 (see FIGS. 7 and 8). The cutting tips 11 of the cutting parts 16, 17 have an acute cutting angle β, see FIG. 13, of, for example, approximately 10 degrees to approximately 18 degrees, further preferably approximately 15 degrees. The partial cutting bodies 13, 14 can be separated from one another in the region of the cutting parts 16, 17. The cutting parts 16, 17 are in each case formed on a front region 15 of the partial cutting body 13, 14 facing the adjacent partial cutting body 13, 14.

In addition to the cutting body 9 of each tool part 4, 5, which includes the partial cutting bodies 13, 14 forming the cutting parts 16, 17, each tool part 4, 5 furthermore has the tool part base 12. The cutting body 9, specifically the partial cutting bodies 13, 14 thereof, can be displaced in an axial direction a relative to the tool part axis. As illustrated in FIGS. 6 and 8, the first partial cutting body 13 can be displaced in an axial direction-a, starting at the initial position according to FIG. 4 or FIG. 7, respectively, while the second partial cutting body 14 can be displaced in the opposing axial direction +a. The partial cutting bodies 13, 14 are mounted on the tool part base 12 in a linearly shiftable manner for this purpose. Alternatively, however, it would also be possible to mount the partial cutting bodies 13, 14 directly on the tool jaws 2, 3, even if this embodiment is not preferred.

Facing inwards, in the direction of the free space 26, the tool part base 12 has a wedge structure 19 comprising a wedge peak 20, and, starting at the wedge peak 20, sloping flat guide surfaces 21, which stand at a wedge angle α (see FIG. 2c) to the axial direction a, as can in particular be seen in FIGS. 7 and 8. The wedge angle α is preferably between 5 degrees and 15 degrees, in particular approximately 9 degrees. The guide surfaces 21 of the tool part base 12 thereby form web-like partial regions of the wedge structure 19 of the tool part base 12, as can also be seen in FIG. 2c. In practice, only a guidance on individual web-like partial regions, which are aligned in the axial direction a, takes place thereby. A guide of the partial cutting bodies 13, 14 on the complete surface of the wedge structure 19 is generally also possible, even though such an embodiment is not preferred, however. The web-like partial regions in a radially outer region of the wedge structure 19 or of the tool part base 12, respectively, provides for a direct dissipation of the forces linearly downwards, i.e. into the respective tool jaw 2, 3, without initially dissipating the forces in a curve onto a lower region of the wedge structure 19 facing the tool jaws 2, 3. In the case of this exemplary embodiment, the guide surfaces 21 are arranged mirror-symmetrically to a cross-sectional plane of the wedge structure 19, in which the common wedge peak 20 is formed.

The respective tool part base 12 has contact surfaces 35, 36, 37, 38. These tool part bases 12 come to bear against one another with these contact surfaces 35, 36, 37, 38 when the tool jaws 2, 3 are essentially completely moved together.

An axial end stop 22, which specifies a length of the cable 8, which is inserted into the stripping tool 1, is also provided. The axial end stop 22 is provided on the second partial cutting body 14 only in an exemplary manner. The axial end stop 22 can be displaced, for example, along a guide rail 27, which guide rail 27 is connected to the partial cutting body 14. The guide rail 27 passes through the end stop 22. The end stop 22 can be fixed to the guide rail 27 in a defined position by means of a lock 28, for example a screw. In an alternate embodiment, the end stop 22 is not part of the cutting body 9, but is, e.g., part of a tool jaw 2, 3.

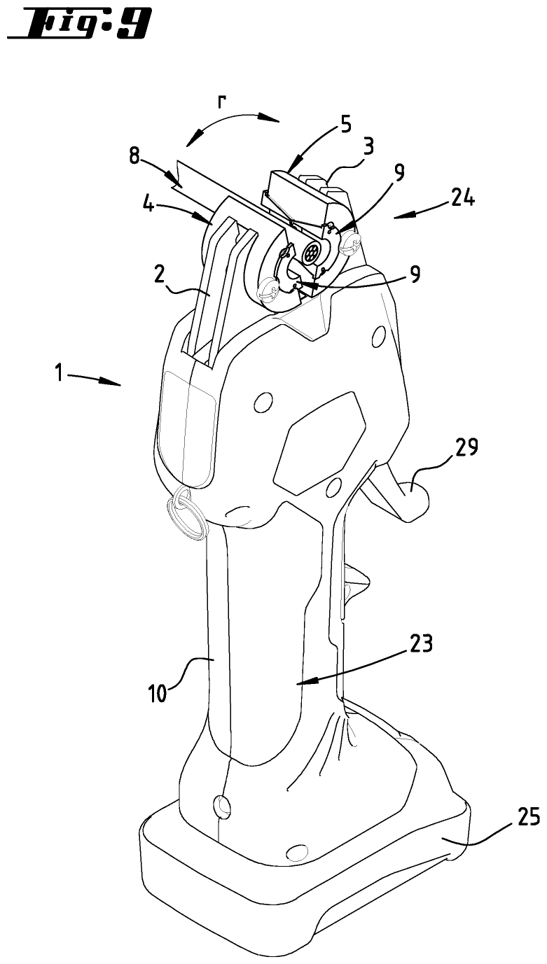

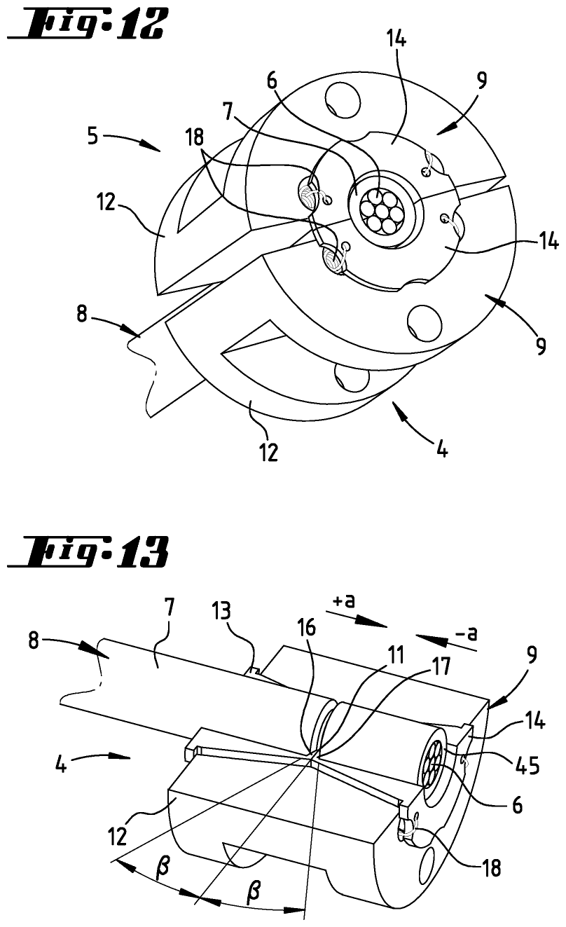

FIGS. 9 to 15 disclose a further possible embodiment of a stripping tool 1. The stripping tool 1 has a working head 24 comprising two tool jaws 2, 3, which can be pivoted relative to one another. Each tool jaw 2, 3 can be pivotable about a separate pivot axis relative to the other tool jaw 2, 3. It can also be one and the same pivot axis.

The stripping tool 1 according to FIGS. 9 to 15 can additionally be formed with a handle region 23, which can be formed, for example, in a rod-shaped manner—as illustrated here—or which can alternatively have, for example, a gun-like shape. The handle region 23 has an actuating element 29, during the actuation of which the user can trigger a stripping process of the stripping tool 1. The user acts on the tool jaws 2, 3 by the actuation of the actuating element 29, in order to move them together, i.e. to displace them towards one another. Moving tool jaws 2, 3 together can furthermore be supported electrically and/or electro hydraulically.

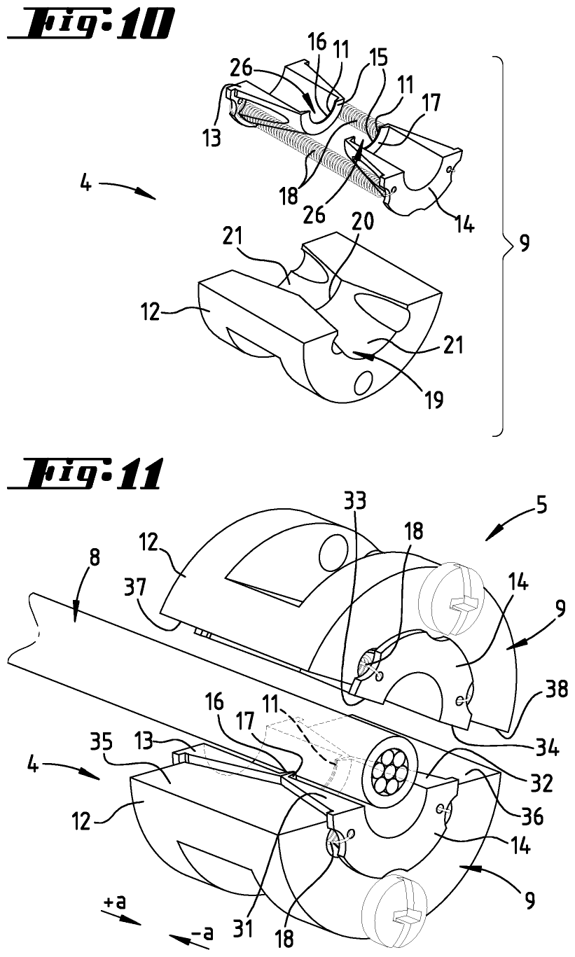

As illustrated in more detail in FIGS. 10 and 11, each of the tool parts 4, 5 has a tool part base 12 and a cutting body 9 which includes two partial cutting bodies 13, 14 The two partial cutting bodies 13, 14 can be displaced relative thereto in the axial direction a, and which are connected to one another by means of resetting elements 18. The resetting elements 18 are formed in an exemplary manner here as tension springs, the resetting force of which acts into a side-by-side position of the two partial cutting bodies 13, 14. The side-by-side position is shown, for example, in FIG. 11. The tool part base 12 has a wedge structure 19 lying on the inside comprising a wedge peak 20 and two conical guide surfaces 21, which slope at a wedge angle α, starting at the wedge peak 20, which guide surfaces 21 slope in opposing axial directions +α and −α. In contrast to the embodiment according to FIGS. 1 to 8, the guide surfaces 21 are not flat, but, in fact, curved, in particular semi-circularly—based on a cross-section. The inner diameter of the tool part base 12 widens outwards due to the conical formation.

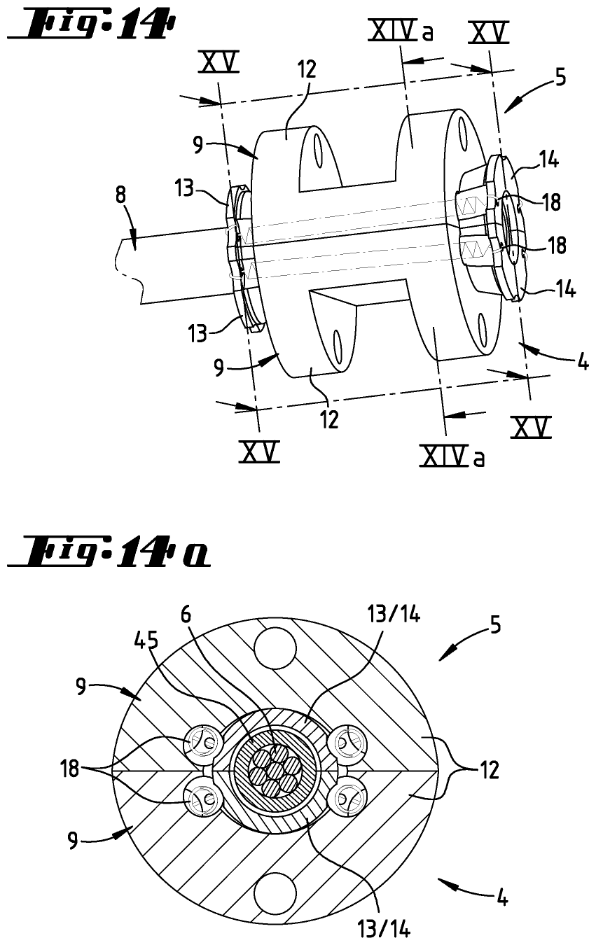

As can further be gathered in particular from FIGS. 10 and 11, the two partial cutting bodies 13, 14 of the cutting body 9 are also formed conically. The outer diameter of the partial cutting body 13, 14 changes along the axial direction a so as to correspond in shape to the guide surfaces 21 of the wedge structure 19 of the tool part base 12, whereby the narrower end of the conical shape is positioned in the region of the wedge peak 20 of the wedge structure 19. Starting at an axial center of the entire cutting body 9, the two partial cutting bodies 13, 14 thus widen outwards (based on the surrounding area of the stripping tool 1). Due to the corresponding conical shape of the tool part base 12 and of the partial cutting bodies 13, 14, the latter, in addition to the axial displaceability, can be pivoted about a longitudinal extension of the partial cutting bodies 13, 14 and can thus also preferably be pivoted about a cable 8, which is to be stripped. Each partial cutting body 13, 14 can, for example, pivot by approximately 2.5 degrees, relative to one another accordingly by 5 degrees. The conical shape furthermore provides the centering of the partial cutting bodies 13, 14 relative to the tool part base 12 in the course of the displacement process of the partial cutting bodies 13, 14 when moving together the tool parts 4, 5 because the diameters of partial cutting bodies 13, 14 and guide surfaces 21 no longer match, i.e. are different based on one and the same cross-sectional plane. A line contact of tool part base 12 and partial cutting bodies 13, 14 thus results. This can in particular be gathered from FIG. 14a.

With regard to differing designs compared to the first embodiment of the stripping tool 1, the formation of the tool parts 4, 5 described with regard to FIGS. 9 to 15 can also be provided in the embodiment of FIGS. 1-8. The differing design, in particular the conical shape, is in particular not limited to tool jaws 3, 4, which can be pivoted to one another.

As according to the embodiment of FIGS. 1 to 8, the stripping tool 1 according to FIGS. 9 to 15 can also have two opposite cutting parts 16, 17, the cutting depth of which is identical or slightly smaller than a measure of a radial thickness of the insulation sheath 7 of the cable 8. For example, the cutting depth can correspond approximately to 0.8-times to 0.95-times the radial thickness of the insulation sheath 7, so that the cutting tips 11 do not engage the cable core 6 when carrying out the cutting process, and preferably a thin web, which can be easily separated by means of tearing, thus remains between the cable core 6 and the cutting tip 11, adjacent to the cable core 6.

The cable 8 may include a fine-wired cable core 6, which includes a plurality of individual strands. The cable 8 can furthermore also be formed as a flat cable, in the case of which the individual strands are present in the shape of thin flat plates. The insulation sheath 7 can be made of rubber, polyethylene, polyvinylchloride, or other materials.

FIG. 16 shows an alternative embodiment of a pair of tool parts 4, 5. In contrast to the embodiment according to FIG. 15 or also of FIGS. 7 and 8, the tool parts 4, 5 have two partial cutting bodies 13, 14, which do not have a cutting parts 16, 17 each. In contrast, only one of the partial cutting bodies 13, 14 has a cutting parts, for example cutting parts 17, while the other partial cutting body 13, 14 has a holding element 30. According to the embodiment illustrated in an exemplary manner in FIG. 16, the first partial cutting body 13 has the holding element 30, and the second partial cutting body 14 has the cutting parts 17. This proposed formation is identical for both opposite tool parts 4, 5. According to this embodiment, the first partial cutting bodies 13 of the first and second tool parts 4, 5 are formed for the fixation of the cable 8 which is to be stripped by the corresponding holding elements 30, while the second partial cutting bodies 14 of the first and second tool parts 4, 5 cut the insulation sheath 7 of the cable 8. The holding elements 30 preferably cooperate only with the outer surface of the cable 8, thus the insulation sheath 7. The holding elements 30 preferably do not engage with the insulation sheath 7 or only with a portion of the thickness of the insulation sheath 7.

A further embodiment can provide that the holding elements 30 and the cutting parts 17 are not located directly opposite one another, based on the same radial cross-section of the partial cutting bodies 13, 14, but, in contrast, are arranged diagonally, namely in such a way that the holding element 30 of the first tool part 4 is located opposite the cutting parts 17 of the second tool part 5 and that the holding element 30 of the second tool part 5 is located opposite the cutting parts 17 of the first tool part 4.

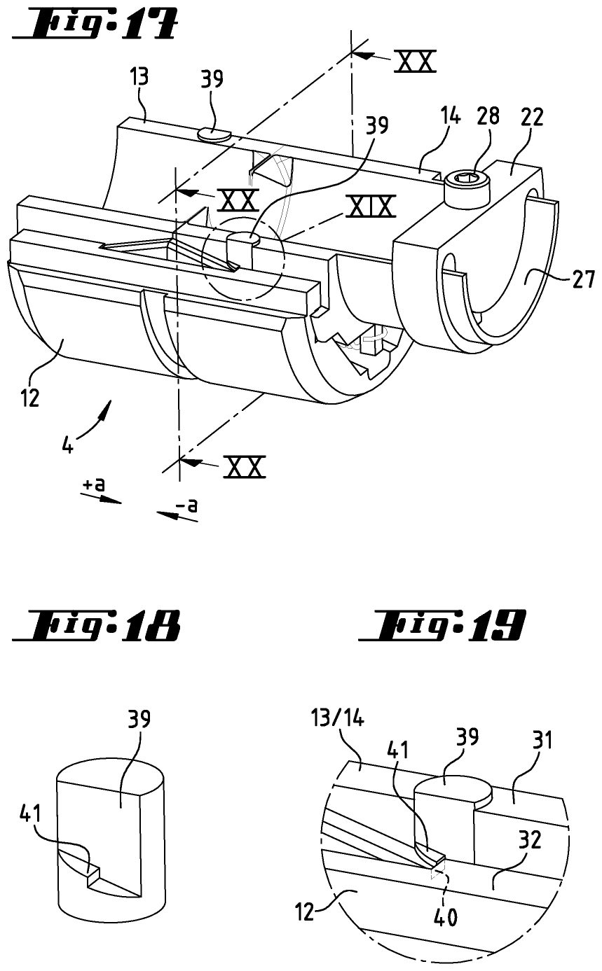

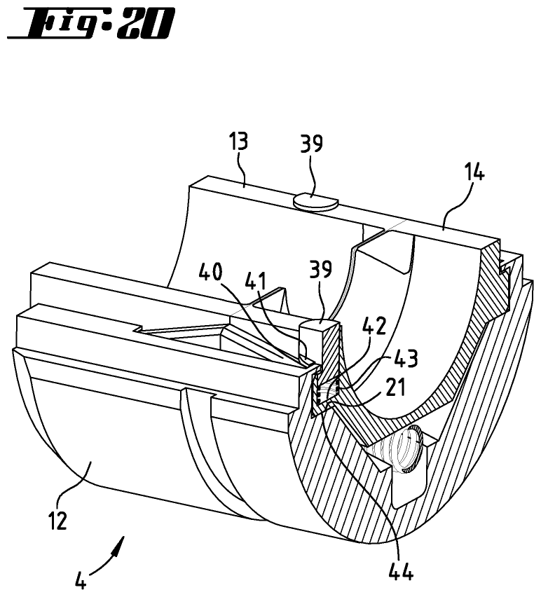

With reference to FIGS. 17 to 20, an embodiment is illustrated, which is a possible design even independently of the concretely illustrated embodiment of the tool parts 4, 5 for all of the tool parts 4, 5 described here. This embodiment relates to a further option for attaining the desired holding force, which is required for changing from the notching into the insulation sheath 7 to the axial shifting of the partial cutting bodies 13, 14 when carrying out a cutting process. As can be seen, the holding force is thereby attained by means of a journal 39, which is guided in the partial cutting body 13, 14 and which is under spring force from a spring element 43 and which can cooperate with a stop 40 formed on the tool part base 12 until a state, as it is given, for instance, by FIGS. 3 and 4. The journal 39 thereby has a protrusion 41, which abuts against the stop 40, as illustrated in FIG. 19, and which is displaced below the level of the stop 40 when lowering the journal 39, and which is subsequently shifted in the axial direction a below the stop 40 in a guide groove 42 of the tool part base 12. The lowering of the journal 39 is triggered by further moving together the tool jaws 3, 4 or tool parts 4, 5, respectively, for example starting at the position illustrated in FIGS. 3 and 4. By means of further moving together the tool parts 4, 5, the resetting force of the spring element 43, which is coupled to the journal 39, is overcome, and the corresponding displacement of the partial cutting bodies 13, 14 relative to the tool part base 12 is attained. This is thus a generation of a holding force, which is essentially based on a positive connection.

The mode of operation of the illustrated stripping tool 1 will be described in more detail below, initially in connection with a method for stripping a cable 8, which is inserted into the stripping tool 1.

The user initially places the cable 8, which is to be stripped, between the tool jaws 2, 3 of the working head 24 of the stripping tool 1. The user thereby preferably places the cable 8 with a free end region against the end stop 22, which later defines that end section of the cable 8, on which the insulation sheath 7 was removed. The user then actuates the stripping tool 1 via the actuating element 29 and the hydraulic medium pump of the stripping tool 1. A displacement of a ram, which is not illustrated in more detail, which acts on the displaceable first tool jaw 2 according to FIG. 1 or both tool jaws 2, 3 according to FIG. 9, respectively, can be effected within the stripping tool 1. The tool jaws 2, 3 and tool parts 4, 5 are moved together and an axial partial section of the insulation sheath 7 of the cable 8 is cut by using the corresponding cutting parts 16, 17. As long as the cutting parts 16, 17 still have contact only with the insulation sheath 7, frictional forces act on the cutting parts 16, 17, which lead to a movement inhibition of the partial cutting bodies 13, 14, based on an axial displacement. When the user displaces the tool jaws 2, 3 and thus also the tool parts 4, 5 closer towards one another in a further step, an elimination of the movement inhibition occurs, preferably due to the forces, which then act as a whole on the tool parts 4, 5, in particular optionally a self-locking effect of the cutting parts 16, 17, whereby the forces acting in the opposing direction on the oblique surfaces of the cutting parts 16, 17 add up to a resulting total force in the axial direction a. The axial displacement of the partial cutting bodies 13, 14 takes place thereby. This, in turn, then leads to a severing or at least a notching, respectively, of the insulation sheath 7, whereby the cutting tips 11 of the cutting parts 16, 17 do not yet contact the cable core 6 and are thus still spaced apart from the cable core 6 at a very small distance. In view of different cables possibly, it cannot be excluded, that in some cases the cutting tips may contact the cable core. Due to the axial displacement of the partial cutting bodies 13, 14, the insulation sheath 7 is finally torn and a torn-off end region of the insulation sheath 7 is shifted relative to the cable core 6.

The cutting tips 11 have at an end in circumferential direction edge regions. As soon as preferably at least the edge regions of the cutting tips 11 of the cutting parts 16, 17 come into contact with one another when the cutting process progresses, the opposite cutting parts 16, 17 act like a single body, on which forces act from opposing directions. These forces add up to a total force, which acts in the axial direction a (or +a and −a, respectively). The resulting force is, for example, in the magnitude between 10% and 20% of the applied force of the stripping tool. The movement inhibition, in particular optionally self-locking of the cutting parts 16, 17, is eliminated, and a displacement of the two partial cutting bodies 13, 14 of the cutting body 9 thus occurs relative to the respective tool part base 12, namely in each case along the sloping guide surfaces 21 (web-like partial regions) of the wedge structure 19. The cutting parts 16, 17 of the tool parts 4, 5 can be separated from one another in the region of the cutting tips 11 for this purpose. In the partially moved-together initial position of the tool jaws 2, 3 according to the given embodiment, the cutting tips 11 are preferably located above the wedge peak 20 of the wedge structure 19, i.e. that the wedge peak 20 and the cutting tip 11 are preferably positioned in one and the same cross sectional plane of the tool parts 4, 5.

Due to the continued application of force of the tool jaws 2, 3, the two partial cutting bodies 13, 14 are pushed apart along the guide surfaces 21 of the wedge structure 19, whereby the likewise separating cutting parts 16, 17 effect the shifting of the severed or almost severed partial section of the insulation sheath 7 relative to the cable core 6. A stripped partial section of the cable 8 is created thereby. The user can subsequently pull the partial region of the insulation sheath 7, which was separated on the end side and which abuts against the end stop 22, off the cable core 6 particularly easily, for example by pulling on the residual remaining cable 8.

The tool parts are preferably designed to cut cross sections between in particular 25 mm² and 300 mm². In practice, the proposed stripping tool has proven itself, for example, for cables, the cable core of which approximately has a diameter of 9 mm to 11 mm, and the insulation sheath of which has an outer diameter of approximately 13 mm to 19 mm. The cutting tip of the cutting parts, which is preferably formed to be semicircular, can limit, for example, a free space, which has a diameter of 12 mm. In particular an angle between approx. 5 degrees and 20 degrees has turned out to be favorable as cutting angle of the cutting parts. The above-mentioned information, however, is to only be understood in an exemplary manner in order to describe the approximately magnitude of the stripping tool or the components thereof, respectively, and are not to be understood to be limiting in any way.

The stripping tool 1 illustrated in FIG. 9 comprising two tool jaws 2, 3, which can be pivoted towards one another, works in a similar way. During the actuation of the actuating element 29, the tool jaws 2, 3 with the tool parts 4, 5 arranged thereon pivot towards one another and preferably likewise initially essentially effect a cutting of a partial section of the insulation sheath 7 of the cable 8 at least in two operating steps and subsequently, with continued application of force, a separating of the axial partial sections of the insulation sheath 7 by means of the axial displacement of the opposite cutting bodies 9 or the partial cutting bodies 13, 14 thereof, respectively, relative to the tool part base 12 of the respective tool part 4, 5. The cutting bodies 9 each have the shape of two half conical shapes, which are placed side by side with the narrower front sides. The wedge peak 20 of the wedge structure 19 of the tool part base 12, from which the two half-conical guide surfaces 21 start, which each slope in opposite axial directions +a and −a, is placed at the transition region between the two half conical shapes. The two partial cutting bodies 13, 14 are connected to one another by means of the resetting element 18, whereby the resetting force of the resetting element 18 presses the cutting parts 16, 17 against one another, as illustrated in FIG. 13. This refers to the partially moved-together initial position of the tool jaws 2, 3 of the stripping tool 1, in the case of which an axial displacement of the partial cutting bodies 13, 14 in the opposite axial directions a has not been triggered yet. The insulation sheath 7 of the cable 8 is severed or almost severed in this state but is not yet shifted relative to the cable core 6. An elimination of the movement inhibition of the opposite cutting parts 16, 17 occurs only when force is further exerted by the tool jaws 2, 3, whereby the partial cutting bodies 13, 14 are displaced away from one another opposite the resetting force of the resetting element 18 along the sloping guide surfaces 21 of the tool part base 12, until the end position illustrated in FIGS. 14 and 15 (or FIG. 16, respectively) results.

In the case of a comparison of the initial position of the tool parts 4, 5 illustrated in FIG. 11 and the end position of the tool parts 4, 5 illustrated in FIG. 14 or 15, respectively, the partial cutting bodies 13, 14 (based on a radial direction) protrude beyond the tool part base 12, concretely the contact surfaces 35, 36, 37, 38 thereof, initially in the initial position. When moving together the tool jaws 2, 3, the tool parts 4, 5 initially come into contact with one another at the facing contact surfaces 31, 32, 33, 34 of the partial cutting bodies 13, 14. This can then preferably also effect the displacement of the journal 39, which is illustrated, for example, in FIGS. 17 to 20. The notching into the insulation sheath 7 takes place as part of the displacement, until the contact surfaces 31, 32, 33, 34 meet one another. As a result of further moving together the tool parts 4, 5, the partial cutting bodies 13, 14 are axially moved out due to the mentioned guide surfaces, until the tool parts 4, 5 come to bear against the contact surfaces 35, 36, 37, 38. A further movement in the moved-together direction is no longer possible after this.

A displacement of the partial cutting bodies 13, 14 in the axial direction a takes place in the motion sequence, starting with the placement of the contact surfaces 31, 32, 33, 34 one on top of the other. The slope of the wedge structure 19, defined by the wedge angle α, in particular also determines the displacement of the partial cutting bodies 13, 14 in the axial direction a and thus also the sum of the stripped partial section of the cable 8.

Due to the conical shape of the partial cutting bodies 13, 14 as well as of the tool part base 12, which is formed so as to correspond in shape, it is possible that the partial cutting bodies 13, 14 cannot only be linearly displaced in the axial direction a, but can, in fact, also be pivoted about a longitudinal axis, which is oriented essentially parallel to the axial direction a. This is advantageous in particular in the case of stripping tools 1 comprising pivotable tool jaws 2, 3.

When the stripping tool 1 is opened again after the stripping of the cable 8, the partial cutting bodies 13, 14 are automatically guided against one another by means of the resetting force of the resetting element 18. An additional hand movement by the user is not required.

Even though the method is also described here with regard to individual steps, which can optionally be performed or triggered by a user, the method in the moving-together direction of the tool parts 4, 5 by means of the tool jaws 2, 3 can run continuously, in particular also automatically after a first triggering, until the stripping process has ended. In practice, the course of the differentiation between the two method steps, initially the notching into the insulation sheath and then the shifting of the separated part or parts of the insulation sheath 7, is preferably not separated. An observer only notices the axial displacement of the cutting parts 16, 17, whereby the notching into the insulation sheath 7 has then already taken place.

The stripping tool is focused on that the tool 1 part base 12 and the cutting body 9 having guide surfaces 44, which are operatively connected to one another and which provide for the displacement after overcoming a holding force, whereby the guide surfaces 44 extend at a same obtuse angle to the engagement direction r, whereby an application of force of the cutting body 9 can be attained solely by means of a displacement of the tool jaws 2, 3 in the engagement direction r, which application of force leads to a displacement of the guide surfaces 44 of the cutting body 9, and thus of the cutting body 9, relative to the guide surfaces 44 of the tool part 4, 5 base 12 with a movement component corresponding to the angle in the axial direction a.

The holding force can be given in various ways. It can be attained by means of a corresponding setting of a frictional force, but it can also be attained by means of a positive connection.

According to the proposed formation of the stripping tool 1, an advantageous cutting result and a stripping result results on the cable 8. The stripping tool 1 does not only provide for a notching of the insulation sheath 7 of the cable 8, which can be handled easily, but, in fact, also a shifting or removing, respectively, of the insulation section 45 from the cable 8 core. For this purpose, the tool part 4, 5 has a tool part base 12, which is mounted, in particular in a stationary manner, relative to the tool jaw or which is formed integrally with the tool jaw, and a cutting body 9, which can be displaced relative to the tool part base 12. The cutting body 9 can be displaced in the axial direction of the tool part 4, 5 along the oblique guide surface, in the direction of the longitudinal extension of the cable 8 arranged between the opposite tool parts 4, 5.

In addition to the axial displaceability of the cutting body 9, the tool part 4, 5 itself and/or the cutting body 9 can preferably be pivoted about a longitudinal axis corresponding to the axial direction relative to the tool jaw or to the tool part base 12, respectively. The pivotability can be given about a comparatively small pivot angle, preferably approximately between 1 degree and 5 degrees. Independently thereof or in addition, the tool part base 12 can in particular have a play to the tool jaw in order to be able to dissipate an acting force, which is introduced into the cable 8 to cut via the tool jaw, during the cutting process, namely so that the cutting parts of the opposite tool parts 4, 5 do not cant or block one another, respectively.

The stripping tool 1 can carry out a cutting of the insulation sheath 7 and shifting of the insulation sheath 7 relative to the cable core 6 in two consecutive steps by means of the tool parts 4, 5 formed in this way. The shifting of the insulation sheath 7 can preferably occur only after overcoming the holding force. The holding force does not yet allow for a movement between the guide surfaces 44, which are operatively connected. The holding force can be attained by setting the frictional force between the cutting body 9 and the insulation sheath 7. As described, said holding force can also be attained by means of a positive connection. As long as the cutting parts are only in contact with the insulation sheath 7 of the cable 8 but are not yet in contact with the cutting parts of the opposite tool part 4, 5, only the frictional force between the cutting parts and the insulation sheath 7 act on the cutting parts. A self-locking interlocking of the cutting parts preferably results therefrom, in the case of which a displacement of the cutting body 9 relative to the tool part base 12 in the axial direction does not yet take place. A force acting in the axial direction, which displaces the cutting body 9 along the guide surface relative to the tool part base 12, is created only when the opposite cutting parts of the stripping tool 1 come into contact with one another or virtually into contact in a second step.

This leads to a shifting of the notched end section, which is the insulation section 45, of the insulation sheath 7 relative to the cable 8 core, whereby the end section can be removed from the cable 8 core in terms of handling. Bringing the tool jaws 2, 3 together effects the notching of the insulation sheath 7 as well as the shifting of the insulation sheath 7 relative to the cable 8 core.

When the opposite cutting parts contact one another or contact one another except for one or a few millimeters (or fractions thereof), namely when the insulation sheath 7 is completely or almost severed, the system of the opposite cutting parts can be considered to be a single body, on which two forces, which oppose one another, act. An axial force results from the opposing forces, which act essentially transversely to the longitudinal extension of the cable 8.

The situation of the cutting parts, which stabilizes itself beforehand, is eliminated and the cutting body 9 is shifted relative to the tool part base 12 of the tool part 4, 5. The resulting axial force is, for example, in the magnitude between 10 percent and 20 percent of the applied force of the stripping tool 1. This is sufficient in order to shift the insulation sheath 7 relative to the cable 8 core even in the case of comparatively large cable 8 cross sections, optionally also with a comparatively hard material of the insulation sheath 7.

Due to the axial shifting, the end-side, notched end section, which is the insulation section 45, of the insulation sheath 7 can be separated from the remaining insulation sheath 7, even if the end section has not been completely cut through yet. The force generated in the axial direction can optionally also produce a tear-off, which is still required.

Due to the fact that the insulation sheath 7 does not have to be cut through completely prior to the displacement of the cutting body 9 relative to the tool part 4, 5 base 12, a certain distance between the cutting parts and the cable 8 core can be maintained, which prevents a notching of the strands of the cable 8 core.

The above-mentioned principle of the stripping tool 1 can be applied to cables 8 with different outer diameters. The stripping tool 1 is furthermore also suitable for cables 8, which have several insulation sheaths 7. The insulation material itself can be softer or harder, for example made of rubber, PVC, PE, or others. The cable 8 core of the cable 8 can be massive or can consist of several strands. The shape of the cutting parts can additionally also be adapted to different cross sectional shapes of the cable 8, for example to flat cables 8, sectioned cables 8, or cables 8 comprising a plurality of separately insulated lines.

The tool parts 4, 5 are preferably designed to cut cross sections between in particular 25 mm² and 300 mm². In practice, the proposed stripping tool 1 has proven itself, for example, for cables 8, the cable 8 core of which approximately has a diameter of 9 mm to 11 mm, and the insulation sheath 7 of which has an outer diameter of approximately 13 mm to 19 mm. The cutting tip of the cutting parts, which is preferably formed to be semicircular, can limit, for example, a free space, which has a diameter of 12 mm. In particular an angle between approx. 5 degrees and 20 degrees has turned out to be favorable as cutting angle of the cutting parts.

The above-mentioned information, however, is to only be understood in an exemplary manner in order to describe the approximately magnitude of the stripping tool 1 or the components thereof, respectively, and are not to be understood to be limiting in any way.

The tool part base 12 advantageously has a wedge structure comprising at least one guide surface or at least two guide surfaces 44, which taper towards a common wedge peak in opposing axial directions. A wedge angle of the wedge structure thereby specifies the angle of the guide surfaces 44 to the axial direction of the tool part 4, 5. The wedge angle, i.e. the slope of the guide surfaces 44 is preferably between 5 degrees and 15 degrees, preferably approx. 9 degrees. Based on the axial direction of the tool part base 12, the wedge peak of the wedge structure is arranged in an axial position, which, in the initial position, is assigned to the axial position of the cutting tip, preferably corresponds approximately to the axial position of the cutting tip of the cutting parts. This is then preferably simultaneously also that axial position, in which the cutting of the insulation sheath 7 of the cable 8 takes place in the initial position of the stripping tool 1. As soon as the insulation sheath 7 is cut through completely or almost completely and the cutting tips of the opposite tool parts 4, 5 thus meet one another or at least further approach one another, the system of the two opposite cutting parts can be considered to be a body, on which forces act, which oppose one another based on the radial direction and which then result in a total force in the axial direction and displace the cutting body 9 including the cutting parts thereof in the axial direction, whereby the cutting body 9 is shifted on the guide surface of the wedge structure assigned to it. This then lastly effects the stripping of the cable 8. According to one embodiment, the entire surface of the wedge structure can serve as guide surface. It is preferred, however, that only individual, in particular strip-shaped partial regions form the guide surface.

The cutting body 9 is preferably formed in two pieces, comprising two partial cutting bodies, which can be displaced in opposing axial directions when—as described above—the opposite cutting parts of the stripping tool 1 come into contact with one another or when the opposite forces acting on the oblique surfaces of the cutting parts, respectively, result in an axial force. One of the partial cutting bodies can also be formed to only hold or clamp the cable 8, respectively. Due to the shape of the cutting parts, the axial force acting on the partial cutting body 9 acts in that axial direction, which faces away from the respective other partial cutting body 9.

A first partial cutting body 9 of the cutting body 9 of a tool part 4, 5 can have, for example, a holding element, which fixes the cable 8, which is to be stripped. In contrast, a second partial cutting body 9 of the same cutting body 9 or tool part 4, 5, respectively, has a cutting parts, which distances itself from the holding element due to the opposing axial displacements of the two partial cutting bodies. A shifting of the insulation sheath 7, being normally the insulation section 45, over a partial section of the length of the cable 8 is attained thereby. The displacement of the guide surfaces 44 to one another as part of a stripping process can also have the result, for example, that the tool jaw or the stripping tool 1 as a whole, respectively, is additionally also displaced relative to the cable 8 or the surrounding area thereof, respectively, in particular in the case of cables 8, the long end of which, which faces the free end region, is immovably secured in a surrounding area, which can be the case, for example, in the case of underground cables 8.

Alternatively, both partial cutting bodies of the same tool part 4, 5 can each have a cutting parts, which can be displaced in opposing axial directions. In combination with the above-described wedge structure of the tool part base 12, it can be attained that each partial cutting body 9 and thus also each cutting parts is moved along a guide surface of the wedge structure, namely in particular in the direction of a sloping ramp of the wedge structure. This also results in the described stripping of the cable 8.

It is furthermore also possible that opposite tool parts each have a first partial cutting body 9 comprising a cutting parts and a second partial cutting body 9 comprising a holding element. The cutting parts of the first and of the second partial cutting body 9 can thereby be positioned so as to be diagonally offset to one another. This means that a cutting parts of a first tool part 4, 5 is located opposite a holding element of the second tool part 4, 5 and that a holding element of the first tool part 4, 5 is located opposite a cutting parts of the second tool part 4, 5. A cutting parts of a first tool part 4, 5 thus does not cut against an opposite cutting parts, but, in fact, against a holding element. As soon as a cutting parts of the first tool part 4, 5 and a holding element of the second tool part 4, 5 thus contact one another or almost contact one another when the opposite tool parts 4, 5 move together, the described axial displacement of the cooperating partial cutting bodies of first and second tool part 4, 5 takes place. A holding element could also be formed by a cutting parts, which is formed to be blunt or round or which has a sawtooth profile.

In one embodiment, it is provided that the first partial cutting body 9 has a first cutting parts on a front region facing the second partial cutting body 9 and that the second partial cutting body 9 has a second cutting parts on a front region facing the first partial cutting body 9. Due to this design, the forces acting on the cutting body 9 can be distributed symmetrically to the two partial cutting bodies. This can advantageously result in a force, which is equally sized in opposing axial directions, so that the partial regions of the insulation sheath 7 of the cable 8 on the left and on the right of the notching point are shifted in opposing directions relative to the cable 8 core.

In the case of the axial displacement of the partial cutting bodies away from one another, not only the cutting body 9 is additionally separated, but, in fact, also the two cutting parts, whereby each cutting parts closes the front side of the respective partial cutting body 9. At least one of the cutting parts pushes the insulation sheath 7 in front of it during the axial displacement.

The two partial cutting bodies can furthermore be connected by means of at least one resetting element, whereby a resetting force of the resetting element seeks to move the two partial cutting bodies towards one another. The resetting element can in particular be a spring element, for example a helical spring or a leaf spring, the resetting force of which acts in a direction, which moves the two partial cutting bodies towards one another.

The resetting element can end, for example, on a front side of the respective partial cutting body 9, which faces away from the other partial cutting body 9. The force thus acts on the outer sides of the cutting body 9 and connects the partial cutting bodies over the entire axial longitudinal extension thereof. Alternatively, it is also possible that the resetting element is arranged on the tool part base 12 or the tool jaw of the stripping tool 1. A pressure spring, which acts on the cutting body 9 from the outside, namely on a front side, which faces away from the cutting parts of the cutting body 9, is recommended in this case. The resetting element can also be formed as spring element in this case. In particular a leaf spring is advantageous thereby.

The resetting element ensures that the partial cutting bodies are displaced into an initial position, in which, for example, the cutting parts or a cutting parts and a holding element bear against one another. A displacement opposing the resetting force of the resetting element results only during the axial displacement of the two partial cutting bodies relative to one another, which follows the notching.

The cutting body 9 or partial cutting body 9, respectively, of the respective tool part 4, 5 can preferably be pivoted about an axial longitudinal extension of the tool jaw relative to the tool jaw. The pivotable arrangement of the cutting body 9 or partial cutting body 9, respectively, on the tool jaw can advantageously be used to attain a pivoting of a cutting parts around the insulation sheath 7 of the cable 8. This improves or supports the cutting result because not only a cutting movement in the radial direction, but also in a circumferential direction of the insulation sheath 7 takes place at least at the beginning of a cutting process. The pivotability of the cutting body 9 or partial cutting body 9, respectively, can furthermore also be used to optionally displace cutting bodies or partial cutting bodies, which are not optimally located in a desired receiving position of the tool jaw, preferably as part of a process of bringing together the tool jaws 2, 3, during which the opposite tool parts 4, 5 are moved towards one another, and one or two opposite pivotable cutting bodies or partial cutting bodies, respectively, are thus also pivoted into a desired position.

It can furthermore be provided that the cutting body 9 and the partial cutting body 9 are formed conically. A first partial cutting body 9 can in particular taper in the axial direction towards an adjacent second partial cutting body 9 of the same tool part 4, 5, and a second partial cutting body 9 can taper in the opposing axial direction. According to this design, the partial cutting bodies are, for example, not formed as half cylinders, but, in fact, conically, whereby the diameter thereof tapers. This conical design provides for the pivoting of the partial cutting body 9 about a longitudinal axis of the tool part 4, 5. The cutting body 9 or partial cutting body 9, respectively, can pivot in particular by 1 degree to 5 degrees, in particular approximately 2.5 degrees. Corresponding to the conical formation of the cutting body 9 or partial cutting body 9, respectively, the tool part base 12 is preferably also formed conically on the side facing radially inwards. The conical shapes and sizes of the tool part base 12 and of the cutting body 9 correspond to one another in particular in such a way that, in the initial position, they preferably bear fully against one another. As soon as an axial displacement of the cutting body 9 or partial cutting body 9, respectively, relative to the tool part base 12 takes place, however, the diameters of tool part base 12 and cutting body 9 or partial cutting body 9, respectively, no longer match based on the same cross sectional plane, so that the tool part base 12 and the cutting body 9 or partial cutting body 9, respectively, only still contact one another linearly on their surfaces facing one another. The cutting body 9 or the partial cutting bodies, respectively, is or are thus particularly preferably aligned relative to the tool part base 12 in the axial direction. The longitudinal axes of two partial cutting bodies within the tool part base 12 also remain parallel to one another.

In the case of the formation of the cutting body 9 with two partial cutting bodies, it can in particular be provided that each partial cutting body 9 can be pivoted by approximately 2.5 degrees. A corresponding movement of the partial cutting bodies and thus also of the assigned cutting parts and/or holding elements is attained thereby while moving together the tool parts 4, 5, while the one cutting parts or the cutting parts, respectively, notch the insulation sheath 7 of the cable 8. An axial displacement of the cutting body 9 or of the partial cutting bodies in the axial direction, respectively, preferably does not yet take place in this section of the cutting process.

It can in particular be provided that the cutting body 9 or the partial cutting bodies, respectively, have a pretensioning into a pivoted-forward position. This can lead to the already mentioned more favorable cutting behavior of the one or of the cutting parts, respectively. The tapering formation of the conical partial cutting body 9 or cutting body 9, respectively, additionally ensures that the axes of the partial cutting bodies remain parallel to one another, if possible.

The cutting body 9 of the tool part 4, 5 can furthermore have an end stop for the cable 8 received therein. The axial end stop of the cutting body 9 limits the length of the cable 8 inserted between the tool jaws 2, 3 of the stripping tool 1. A length of the core of the cable 8 exposed by the stripping can be simultaneously determined therewith.

The axial end stop can particularly preferably be manually displaced relative to the tool jaws 2, 3 by a user of the stripping tool 1. The end stop can be displaced outwards, for example along a guide rail of the cutting body 9 of the tool part base 12 or of the tool jaw. The end stop is thus mounted on the cutting body 9, the tool part 4, 5 base 12, or the tool jaw. It can in particular be provided that, for example, the cutting body 9 has a guide rail, which passes through a partial region of the end stop, and the end stop can thus be displaced towards the tool jaw or can be displaced away from it, respectively.

A lock, which can fix the end stop in a desired position, is thereby preferably assigned to the end stop. According to one embodiment, a latching means or a screw can be provided in this respect, which applies a holding force to the partial region of the cutting body 9, for example the guide rail.

Based on the stripping tool 1, it can lastly also be provided that at least the first tool jaw can be displaced linearly or can be pivoted about a pivot axis relative to the second tool jaw. The tool jaws 2, 3 can thus generally be moved together in different ways. The stripping tools 1 comprising tool jaws 2, 3, which can be shifted linearly to one another, thereby form one group of stripping tools 1. In this case, the stripping tool 1 is formed, for example, so that it has a tool jaw, which is stationary relative to a handle part of the tool body and a tool jaw, which can be shifted linearly, in contrast, whereby the shiftable tool jaw is displaced towards the stationary tool jaw for the stripping process. The second group of stripping tools 1 includes tools, in the case of which at least one tool jaw, but preferably both tool jaws 2, 3, is pivotable about a pivot axis. In the case of two tool jaws 2, 3, which can be displaced towards one another, the tool jaws 2, 3 can be pivotable about a common pivot axis or also about a respective separate pivot axis.

In addition to the stripping tool 1, a pair of tool parts for a stripping tool 1 is proposed, whereby the stripping tool 1 is formed according to the above-described type. The stripping tool 1 thus has a pair of tool parts 4, 5 comprising a first tool part 4, 5 and a second tool part 4, 5, for stripping a cable 8 having a cable 8 core and an insulation sheath 7, whereby cutting parts are further provided for acting on the cable 8 during the stripping process, whereby each tool part 4, 5 has a cutting body 9 for receiving a partial region of the cable 8, whereby the cutting body 9 has a cutting parts comprising a cutting tip, whereby the cutting tip limits a free space of the cutting body 9, in which it is provided to receive the cable 8 core, whereby the tool part 4, 5 has a tool part base 12, which is received on the tool jaw, whereby the cutting body 9 of the tool part 4, 5 can be displaced in an axial direction relative to the tool part base 12 orthogonally to the engagement direction r, whereby the tool part base 12 and the cutting body 9, have guide surfaces 44, which are operatively connected to one another and which provide for the displacement after overcoming a holding force, whereby the guide surfaces 44 extend at a same obtuse angle to the engagement direction r, whereby an application of force of the cutting body 9 can be attained solely by means of a displacement of the tool jaws 2, 3 in the engagement direction r, which application of force leads to a displacement of the guide surfaces 44 of the cutting body 9, and thus of the cutting body 9, relative to the guide surfaces 44 of the tool part base 12 with a movement component in the axial direction corresponding to the angle.

The pair of tool parts 4, 5 is thus designed in such a way that it can fulfill the function in the illustrated manner when being received in a corresponding stripping tool 1. This design results in the advantages and features, which have been described above with regard to the stripping tool 1. The features of the stripping tool 1, which relate to the formation of the tool parts 4, 5, also apply accordingly for the proposed pair of tool parts 4, 5 for a stripping tool 1.

Finally, a method for stripping a cable 8 having a cable 8 core and an insulation sheath 7 is proposed, whereby the method includes the following method steps: arranging the cable 8 between two opposite cutting bodies, which each have at least one cutting parts, of a first tool part 4, 5 and of a second tool part 4, 5;
displacing the first tool part 4, 5 towards the second tool part 4, 5 in an engagement direction r;
cutting an axial partial section of the insulation sheath 7 of the cable 8 by using the cutting parts of the first tool part 4, 5 and of the cutting parts of the second tool part 4, 5;
displacing the cutting body 9 of the tool part 4, 5 relative to a tool part base 12 of the tool part 4, 5 in an axial direction, which is oriented orthogonally to the engagement direction r, whereby guide surfaces 44, which are operatively connected to one another and which extend at a same obtuse angle to the engagement direction r, of the tool part base 12 and of the cutting body 9 provide for the displacement of the cutting body 9 after overcoming a holding force, whereby an application of force of the cutting body 9 takes place solely by a displacement of the tool jaws 2, 3 in the engagement direction r, which application of force leads to a displacement of the guide surfaces 44 of the cutting body 9, and thus of the cutting body 9, relative to the guide surfaces 44 of the tool part base 12 with a movement component in the axial direction corresponding to the angle;
separating the axial partial sections, the insulation sections 45, of the insulation sheath 7 of the cable 8 by displacement of the cutting body 9 relative to the tool part base 12.

The proposed method provides for a procedure in at least two steps. The first step includes the displacement of the opposite tool parts 4, 5 towards one another for cutting the insulation sheath 7 of the cable 8. The tool parts 4, 5 are thereby moved towards one another until the cutting tips of the opposite cutting parts or at least partial regions of the opposite cutting parts come into contact with one another or at least approximately come into contact with one another. During the first method step, a self-locking of the cutting parts preferably takes place, whereby only the cutting of the insulation sheath 7 takes place, but not yet a relevant axial shifting of the cutting parts and thus of the insulation sheath 7 relative to the cable 8 core. The second step of the procedure is triggered in that the user displaces the tool jaws 2, 3 and thus also the tool parts 4, 5 of the stripping tool 1 further towards one another, which results in an elimination of the movement inhibition, in particular optionally of the self-locking effect of the cutting parts, preferably due to the totality of forces, which act on the tool parts 4, 5, and the forces having an opposing effect on the cutting parts add up to a resulting total force in the axial direction, which then lastly effects the axial displacement of the cutting body 9 or of the partial cutting body 9 thereof, respectively. In particular two partial cutting bodies are thus moved away from one another, namely in opposing axial directions, so that the cut end section, the insulation section 45, of the insulation sheath 7 is shifted relative to the cable 8 core of the cable 8.

The displacement of the cutting body 9 relative to the tool part base 12 takes place by means of an application of force by the displacement of the first tool part 4, 5 towards the second tool part 4, 5 and has the effect that at least a partial region of the cutting body 9 of the respective tool part 4, 5 is pressed onto at least one guide surface of a wedge structure, which slopes in the axial direction. In response to continued application of force, the cutting body 9 or the partial region of the cutting body 9 is guided downwards along the sloping guide surface, starting at a wedge peak of the wedge structure, and is thus simultaneously displaced in the axial direction, until an end position is reached. The same results in the case of an adapted conical formation of the cooperating guide surfaces 44. The end position is specified by the tool jaws 2, 3, which are moved together or optionally by a resetting element, respectively, the resetting force of which wants to displace the cutting body 9 or the partial region of the cutting body 9 back into the initial position, or a resetting element, respectively, which connects two partial cutting bodies of the cutting body 9 to one another and seeks to displace them one on top of the other. The end position is further specified at least by a meeting of the tool parts 4, 5, in which the cutting means are arranged. The end position is further specified at least by a meeting of the tool part base 12 of the first tool part 4, 5 and the tool part base 12 of the second tool part 4, 5.

The displacement of the cutting body 9 in the axial direction preferably includes that a first partial cutting body 9 and a second partial cutting body 9 of the cutting body 9 are displaced relative to one another in the opposing axial directions. In particular a symmetry of the displacement movements of the partial cutting bodies relative to the tool part 4, 5 tool part base 12 of the respective tool part 4, 5 can be attained thereby. Starting at the cutting point, a force is thus exerted on the insulation sheath 7 in two opposing directions, which simplifies the stripping of the cable 8. The displacement of the two partial cutting bodies relative to one another can include, on the one hand, that two cutting parts are displaced relative to one another. Alternatively, the displacement of the two partial cutting bodies can include that a first partial cutting body 9 comprising a cutting parts is removed from a second partial cutting body 9 comprising a holding element.

With regard to the two partial cutting bodies of the cutting body 9, it can in particular be provided that each partial cutting body 9 supports a cutting parts, whereby a first cutting parts arranged on a front region of the first partial cutting body 9 facing the second partial cutting body 9 is separated from a second cutting parts arranged on a front region of the second partial cutting body 9 facing the first partial cutting body 9. An in particular central and symmetrical separation of the two cutting parts of the one cutting parts thus simultaneously also takes place when displacing the two adjacent partial cutting bodies away from one another.

### LIST OF REFERENCE NUMERALS

| | |
|---|---|
| 1 | stripping tool |
| 2 | tool jaw |
| 3 | tool jaw |
| 4 | tool part |
| 5 | tool part |
| 6 | cable core |
| 7 | insulation sheath |
| 8 | cable |
| 9 | cutting body |
| 10 | drive device part |
| 11 | cutting tip |
| 12 | tool part base |
| 13 | partial cutting body |
| 14 | partial cutting body |
| 15 | front region |
| 16 | cutting parts |
| 17 | cutting parts |
| 18 | resetting element |
| 19 | wedge structure |
| 20 | wedge peak |
| 21 | guide surface |
| 22 | end stop |
| 23 | handle region |
| 24 | working head |
| 25 | accumulator |
| 26 | free space |
| 27 | guide rail |
| 28 | lock |
| 29 | actuating element |
| 30 | holding element |
| 31 | contact surface |
| 32 | contact surface |
| 33 | contact surface |
| 34 | contact surface |
| 35 | contact surface |
| 36 | contact surface |
| 37 | contact surface |
| 38 | contact surface |
| 39 | journal |
| 40 | stop |
| 41 | protrusion |
| 42 | guide groove |
| 43 | spring element |
| 44 | guide surface |
| 45 | insulation section |
| a | axial direction |
| α | wedge angle |
| β | cutting angle |
| r | engagement direction |

1-15. (canceled)

16. A method for stripping a cable having a cable core and an insulation sheath, the method comprising:
arranging the cable between two opposite cutting bodies, which each have at least one cutting parts, of a first tool part and of a second tool part, the tool parts being carried by tool jaws;
displacing the first tool part towards the second tool part in an engagement direction;
cutting an axial partial section of the insulation sheath of the cable by using the cutting parts of the first tool part and the cutting parts of the second tool part;
displacing the cutting body of each of the tool parts relative to a tool part base of the tool parts in an axial direction, which is oriented orthogonally to the engagement direction, wherein guide surfaces, which are operatively connected to one another and which extend at a same obtuse angle to the engagement direction of the tool part base and of the cutting body, provides for the displacement of the cutting bodies after overcoming a holding force, wherein an application of force of each of the cutting bodies takes place solely by a displacement of the tool jaws in the respective engagement direction of the tool jaw having the respective tool part body and the respective cutting body, which application of force leads to a displacement of the guide surfaces of the cutting bodies relative to the guide surfaces of the tool part base with a movement component in the axial direction corresponding to the angle; and
separating the axial partial sections of the insulation sheath of the cable by displacement of the cutting bodies relative to the tool part base.

17. The method according to claim 16, wherein the displacement of the cutting body relative to the tool part base takes place along at least one guide surface of a wedge structure sloping in the axial direction.

18. The method according to claim 17, wherein the displacement of the cutting body in the axial direction includes that a first partial cutting body and a second partial cutting body of the cutting bodies are displaced relative to one another in opposing axial directions.

19. The method according to claim 18, wherein a first cutting part arranged on a front region of the first partial cutting body facing the second partial cutting body is separated from a second cutting part arranged on a front region of the second partial cutting body facing the first partial cutting body.

20. The method according to claim 16, wherein the displacement of the cutting body in the axial direction includes that a first partial cutting body and a second partial cutting body of the cutting bodies are displaced relative to one another in opposing axial directions.

21. The method according to claim 20, wherein a first cutting part arranged on a front region of the first partial cutting body facing the second partial cutting body is separated from a second cutting part arranged on a front region of the second partial cutting body facing the first partial cutting body.

22. A stripping tool configured to strip a cable having a cable core and an insulation sheath in a stripping process, the stripping tool comprising:
a pair of tool jaws displaceable towards one another in an engagement direction, having a first tool jaw and a second tool jaw, and comprising a pair of tool parts having a first tool part and a second tool part configured to strip the cable, each tool part having a tool part base received on the tool jaw, each tool part comprising a cutting body having cutting parts configured to receive a partial region of the cable and to act on the cable during a stripping process, each cutting body having a free space in which the cable core is configured to be received, each cutting part limiting the free space, wherein the cutting bodies of the tool parts are configured to be displaced in an axial direction relative to the tool part base orthogonally to the engagement direction; and
each of the tool part bases and each of the cutting bodies have guide surfaces, which are operatively connected to one another and which provide for the displacement after overcoming a holding force, the guide surfaces extending at a same obtuse angle to the engagement direction of the tool jaw having the respective tool part base and the respective cutting body, and
wherein an application of force of the cutting body is attainable solely by a displacement of the tool jaws in the respective engagement direction, which application of force leads to a displacement of the guide surfaces and of the cutting bodies relative to the guide surfaces of the tool part base with a movement component corresponding to the angle in the axial direction.

23. The stripping tool according to claim 22, wherein the tool part base has a wedge structure comprising at least one guide surface or comprising at least two guide surfaces, which taper towards a common wedge peak in opposing axial directions.

24. The stripping tool according to claim 23, wherein the cutting body has two partial cutting bodies, which can be displaced relative to one another and in opposing axial directions, comprising a first partial cutting body and a second partial cutting body.

25. The stripping tool according to claim 24, wherein the first partial cutting body has a first cutting part on a front region facing the second partial cutting body and that the second partial cutting body has a second cutting parts on a front region facing the first partial cutting body.

26. The stripping tool according to claim 25, wherein the two partial cutting bodies are connected to one another by at least one resetting element, wherein a resetting force of the resetting element seeks to move the two partial cutting bodies towards one another.

27. The stripping tool according to claim 24, wherein the two partial cutting bodies are connected to one another by at least one resetting element, wherein a resetting force of the resetting element seeks to move the two partial cutting bodies towards one another.

28. The stripping tool according to claim 24, wherein the cutting body and the partial cutting body are formed conically.

29. The stripping tool according to claim 22, wherein the cutting body or the partial cutting body can be rotated about an axial longitudinal extension of the tool jaw relative to the tool jaw.

30. The stripping tool according to claim 22, wherein the cutting body has an end stop for the cable received therein.

31. The stripping tool according to claim 22, wherein at least the first tool jaw can be displaced linearly or can be pivoted about a pivot axis relative to the second tool jaw.

32. The stripping tool according to claim 22, wherein the cutting body has two partial cutting bodies, which can be displaced relative to one another and in opposing axial directions, comprising a first partial cutting body and a second partial cutting body.

33. The stripping tool according to claim 32, wherein the first partial cutting body has a first cutting part on a front region facing the second partial cutting body and that the second partial cutting body has a second cutting parts on a front region facing the first partial cutting body.

34. The stripping tool according to claim 33, wherein the two partial cutting bodies are connected to one another by at least one resetting element, wherein a resetting force of the resetting element seeks to move the two partial cutting bodies towards one another.

35. The stripping tool according to claim 32, wherein the two partial cutting bodies are connected to one another by at least one resetting element, wherein a resetting force of the resetting element seeks to move the two partial cutting bodies towards one another.
